(19) United States
(12) Patent Application Publication
(10) Pub. No.: US 2014/0158616 A1
(43) Pub. Date: Jun. 12, 2014

(54) SYSTEMS, APPARATUS, AND METHODS FOR SEPARATING SALTS FROM WATER

(71) Applicant: Advanced Water Recovery, LLC, Rapid City, SD (US)

(72) Inventors: Rakesh Govind, Cincinnati, OH (US); Robert Foster, Calgary (CA)

(73) Assignee: Advanced Water Recovery, LLC, Rapid City, SD (US)

(21) Appl. No.: 14/099,306

(22) Filed: Dec. 6, 2013

Related U.S. Application Data
(60) Provisional application No. 61/878,861, filed on Sep. 17, 2013.
(60) Provisional application No. 61/757,891, filed on Jan. 29, 2013.
(60) Provisional application No. 61/735,211, filed on Dec. 10, 2012.
(60) Provisional application No. 61/734,491, filed on Dec. 7, 2012.

(51) Int. Cl. C02F 1/52

(52) U.S. Cl. CPC C02F 1/5272
USPC 210/636; 210/702; 210/729; 210/735; 210/650; 210/652

(57) ABSTRACT

A system, method, and apparatus for precipitating a water soluble salt or water soluble salts from water, including adding a water-miscible solvent to a water solution including an inorganic salt. The system, method and apparatus also allow for the separation of the precipitated salt, and for separation of the solvent from the water. In doing so, reclamation of water is provided.

### CROSS-REFERENCE TO RELATED APPLICATIONS

This application claims the benefit of the filing date of U.S. Patent Application No. 61/878,861, entitled, “Apparatus and Method for Separating Salts from Water, filed on Sep. 17, 2013; U.S. Patent Application No. 61/757,891, entitled, “Solvent Precipitation and Concentration of Salts,” filed on Jan. 29, 2013; U.S. Patent Application No. 61/735,211, entitled “Process for Converting Brackish/Produced Water to Useful Products and Reusable Water,” filed on Dec. 10, 2012, and U.S. Patent Application No. 61/734,491, entitled “Process for Converting Brackish/Produced Water to Useful Products and Reusable Water”, filed on Dec. 7, 2012, the disclosures of which are incorporated by reference herein in their entireties.

### FIELD OF THE INVENTION

Aspects of the present invention generally relate to methods of, and apparatus for, separating materials from a liquid, and more specifically relate to methods of, and apparatus for, separating salts from water, such as flowback water from processes such as fracking.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Subsurface geological operations such as mineral mining, oil well drilling, natural gas exploration, and induced hydraulic fracturing generate wastewater contaminated with significant concentrations of impurities. These impurities vary widely in both type and amount depending on the type of geological operation, the nature of the subsurface environment, and the type and amount of soluble minerals present in the native water source. The contaminated water is eventually discharged into surface waters or sub-surface aquifers. In some cases, wastewater generated from drilling and mining operations have resulted in making regional water supplies unusable. Induced hydraulic fracturing (a.k.a. hydro fracturing, or fracking) in particular is a highly water-intensive process, employing water pumped at pressures exceeding 3,000 psi and flow rates exceeding 85 gallons per minute to create fractures in subsurface rock layers. These created fractures intersect with natural fractures, thereby creating a network of flow channels to a well bore. These flow channels allow the release of petroleum and natural gas products for extraction. The flow channels also allow the injected water plus additional native water to flow to the surface along with the fuel products once the fractures are created.

Flowback water, and produced water, from subsurface geological operations contain a variety of contaminants. Often, produced water is “hard” or brackish and further includes dissolved or dispersed organic and inorganic materials. Flowback water can include chemicals used in the fracing operation, such as polymer gels, metals, chemicals and hydrocarbons that are injected along with water to facilitate fracture of the formation during hydro-fracturing. Produced water can include high concentrations of naturally occurring dissolved and suspended solids such as silt, hydrocarbons, multi- and mono-valent salts, metals, BODs, CODs and other contaminants. One common type of contaminant present is salt (e.g., sodium chloride). In all of these cases, there is a need for low energy-consuming and efficient technologies that can recover reusable water from wastewaters. Since all of these waters contain high concentrations of salts, there is need to be able to remove the soluble salts (such as sodium chloride) from water in an effective, efficient, low-energy, and low-cost manner.

As described above, much flowback water may contain salts dissolved in the water. As is known to those of ordinary skill in the art, the solubility rules for salts are as follows:

1. Salts containing Group I elements are soluble (Li⁺, Na⁺, K⁺, Cs⁺, Rb⁺). Exceptions to this rule are rare. Salts containing the ammonium ion (NH₄⁺) are also soluble.
2. Salts containing nitrate ion (NO₃⁻) are generally soluble.
3. Salts containing Cl⁻, Br⁻, I⁻ are generally soluble. Important exceptions to this rule are halide salts of Ag⁺, Pb²⁺, and (Hg₂)²⁺. Thus, AgCl, PbBr₂, and Hg₂Cl₂ are all insoluble.
4. Most silver salts are insoluble. AgNO₃ and Ag(C₂H₃O₂) are common soluble salts of silver; virtually anything else is insoluble.
5. Most sulfate salts are soluble. Important exceptions to this rule include BaSO₄, PbSO₄, Ag₂SO₄ and SrSO₄.
6. Most hydroxide salts are only slightly soluble. Hydroxide salts of Group I elements are soluble. Hydroxide salts of Group II elements (Ca, Sr, and Ba) are slightly soluble. Hydroxide salts of transition metals and Al³⁺ are insoluble. Thus, Fe(OH)₃, Al(OH)₃, Co(OH)₂ are not soluble.
7. Most sulfides of transition metals are highly insoluble. Thus, CdS, FeS, ZnS, Ag₂S are all insoluble. Arsenic, antimony, bismuth, and lead sulfides are also insoluble.
8. Carbonates are frequently insoluble. Group II carbonates (Ca, Sr, and Ba) are insoluble. Some other insoluble carbonates include FeCO₃ and PbCO₃.
9. Chromates are frequently insoluble. Examples: PbCrO₄, BaCrO₄
10. Phosphates are frequently insoluble. Examples: Ca₃(PO₄)₂, Ag₃PO₄
11. Fluorides are frequently insoluble. Examples: BaF₂, MgF₂PbF₂.

Most alkali chlorides (Group 1 elements) are soluble in water. And, the solubility of most salts increases with temperature, as shown in FIG. 1, for some typical salts. Sodium chloride is an example of a highly soluble salt having a solubility that increases with temperature. As described above, sodium chloride is one of the most prevalent contaminants in water (such as flowback water), and so it would be beneficial to be able to remove sodium chloride in an effective, efficient, low-energy, low-cost manner.

However, presently there are no simple methods to remove sodium chloride from water that meet these goals. Two methods that have been traditionally used involve either (1) evaporation of water until the salt solution becomes supersaturated and salt begins to precipitate or (2) by freezing water to form pure ice, which allows the salt concentration to increase in the liquid water portion [this process, coupled with the lowered solubility at freezing temperatures (below 32° F.), allows salt to be precipitated from solution]. Unfortunately, both of these methods consume a large amount of energy, which is undesirable. Further, neither of these processes is rapid.

Additionally, previous patents on recovering water include U.S. Pat. No. 8,158,097 B2, which discusses use of chemical precipitation using reagents to produce commercial products such as barium sulfate, strontium carbonate, calcium carbonate, and crystallizing the chemically treated and concentrated flowback brine to produce greater than 99.5% pure salt products, such as sodium and calcium chloride. This patent also discusses the use of evaporation to concentrate the salt from 15 wt % to about 30 wt % and using reagents selected from the group consisting of sodium sulfate, sodium carbonate, sodium hydroxide, hydrochloric acid and mixtures thereof, and recovering sodium chloride solid and calcium chloride with about 98% purity.

Another patent, U.S. Pat. No. 7,083,730 B2, claims recovery of sodium chloride using reverse osmosis to recover water with the reject of the reverse osmosis process being treated in an electrodialysis system to produce a concentrated stream of sodium chloride, from which sodium chloride can be recovered.

Unfortunately, none of these processes are quick, efficient, low-energy, and low-cost.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

The present invention overcomes the issues with removing contaminants such as salts (e.g., sodium chloride) from water (such as flowback water), as described in the Background. It does so, in one aspect, by using a solvent to precipitate the salt out of solution (i.e., out of the water), and by providing apparatus and methods for same. Other aspects of the present invention may include further processing to (1) remove the precipitated salt from the water and (2) remove the solvent from the water. Another aspect of the present invention is that the method and apparatus accomplish this in an efficient, low-energy, and low-cost manner. Additionally, the salt removed may ultimately be converted into higher value products (in order to offset any cost, or portion of the cost, of the water treatment).

Thus, one aspect of the present invention involves precipitating salt out of the water using a solvent. The solvent may be an organic solvent. To that end, ethanol precipitation is a widely used technique to purify or concentrate nucleic acids. In the presence of salt (in particular, monovalent cations such as sodium ions), ethanol efficiently precipitates nucleic acids. Nucleic acids are polar, and a polar solute is very soluble in a highly polar liquid, such as water. However, unlike salt, nucleic acids do not dissociate in water since the intramolecular forces linking nucleotides together are stronger than the intermolecular forces between the nucleic acids and water. Water forms solvation shells through dipole-dipole interactions with nucleic acids, effectively dissolving the nucleic acids in water. The Coulombic attraction force between the positively charged sodium ions and negatively charged phosphate groups in the nucleic acids is unable to overcome the strength of the dipole-dipole interactions responsible for forming the water solvation shells.

The Coulombic Force between the positively charged sodium ions and negatively charged phosphate groups depends on the dielectric constant (∈) of the solution, and is given by the following equation:

$$F = \frac{{q}_{1} {q}_{2}}{4 {πɛ}_{0} {ɛ}_{r} {r}^{2}} = 8.9875 \times {10}^{9} \frac{{q}_{1} {q}_{2}}{{ɛ}_{r} {r}^{2}} newtons$$

Adding a solvent, such as ethanol to a nucleic acid solution in water lowers the dielectric constant, since ethanol has a much lower dielectric constant than water (24 vs 80, respectively). This increases the force of attraction between the sodium ions and phosphate groups in the nucleic acids, thereby allowing the sodium ions to penetrate the water solvation shells, neutralize the phosphate groups and allowing the neutral nucleic acid salts to aggregate and precipitate out of the solution [as described in Pi\check{s}kur, Jure, and Allan Rupprecht, “Aggregated DNA in ethanol solution,” FEBS Letters 375, no. 3 (November 1995): 174-8, and Eickbush, Thomas, and Evangelos N. Moudrianakis, “The compaction of DNA helices into either continuous supercoils or folded-fiber rods and toroids,” Cell 13, no. 2 (February 1978): 295-306, the disclosures of which are incorporated by reference herein in their entireties].

One aspect of the present invention, then, contemplates that the principles regarding the precipitation of nucleic acids via the introduction of water miscible solvents can also be used to precipitate soluble salts, which, like nucleic acids, have solvation shells formed around the ions. Thus, by lowering the dielectric constant of the solution, the Coulombic attraction between the oppositely charged ions can be increased to cause the neutral salts to precipitate out of solution. This general concept has been discussed by Alfassi, Z B, L Ata. “Separation of the system NaCl—NaBr—NaI by Solventing Out from Aqueous Solution,” Separation Sci. and Technol. 18, no. 7 (1983): 593-601, incorporated by reference herein in its entirety, using data on the solubilities of several salts in a mixture of water-miscible organic solvent (MOS), wherein they found that the mass ratio (a) of the water-miscible organic solvent to the total mass of aqueous solution (the mass of water plus the mass of solvent dissolved in the water), i.e.,

α=M_{MOS}/M_{Aqueous Solution}

can be correlated against the fraction of salt precipitated from a saturated brine solution, f, (i.e., the ratio of mass of salt precipitated to the mass of salt in the brine) as follows:

f=K*α

where K is a precipitation constant. FIG. 2 shows a plot of f versus α for sodium chloride in water using ethylamine as an organic solvent. Ethylamine was selected in the illustrated embodiment of FIG. 2 because it has a number of characteristics that are useful for a solvent in accordance with the principles of the present invention: It has a low heat of vaporization, is completely miscible with water in all proportions, has a low dielectric constant, and can be easily separated from water since its boiling point is quite different than water. The actual amount of salt precipitated is “f” times the mass of salt in a saturated brine solution.

As described above, once salt is precipitated out of solution, another aspect of the present invention involves removing the precipitated salt from the water. For example, in one embodiment, the precipitated salt may be removed from the water via use of apparatus such as hydrocyclones.

A further aspect of the present invention involves removing the solvent from the water following precipitation of salt. The solvent may be removed via multiple methods. In one embodiment, the solvent may be evaporated from the water using apparatus that allows for rapid evaporation of solvent (this apparatus may also assist in removing any remaining precipitated salt). In order to minimize the energy for removal of organic solvent after separation, the use of low-boiling temperature organic solvents is contemplated.

In another embodiment, the solvent may be removed using alternate apparatus, such as a packed tower or spray tower. Alternatively, a multi-effect distillation column may be used to remove the solvent from the water.

These described methods and apparatus for solvent removal involve vaporization of the solvent. However, non-vaporization apparatus and methods may be used to remove the solvent from the water. For example, membranes may be used to remove the solvent. Such a method may include one membrane or multiple membranes. Further, such a method may include one or more of ultrafiltration membranes, nanofiltration membranes, and reverse osmosis in varying configurations.

The membranes described above may also be used to separate a precipitated salt or salts from the water, as opposed to, or in addition to, removing solvent from the water.

Thus, various aspects of the invention regarding membrane separation may include (1) using the membrane or membranes as described herein in conjunction with the solvent to concentrate salts and precipitate them in the membrane itself; (2) using the membrane systems described herein to reject solvent so that it is recaptured for reuse; and/or (3) using the solvent in solution to prevent fouling of the membrane via saturation gradient control.

There are other aspects of the present invention related to this concept of preventing fouling of a membrane or membranes. These additional aspects may use processes such as forward osmosis to prevent fouling.

These and other advantages of the application will be apparent to those of skill in the art with reference to the drawings and the detailed description below.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a graph showing a plot of aqueous solubility of some typical salts as a function of temperature.

FIG. 2 is a graph showing a plot of a fraction of salt precipitated from water using various amounts of ethylamine as the solvent.

FIG. 3A is a schematic showing an embodiment of a method and apparatus for precipitation of salt in accordance with the principles of the present invention.

FIG. 3B is a schematic showing an embodiment of a method and apparatus for precipitation of salt in accordance with the principles of the present invention, including an underflow degassing process and system for removal of solvent, among other materials.

FIG. 3C is a schematic showing an embodiment of a method and apparatus for the precipitation of salt in accordance with the principles of the present invention, including an overflow degassing process and system for removal of solvent, among other materials.

FIGS. 4A and 4B are cross-sectional views of an embodiment of apparatus used in separating solvent from a liquid (e.g., water) in the underflow and overflow degassing processes and systems depicted in FIGS. 3B and 3C.

FIG. 5 is a schematic of another embodiment of a precipitation process and system showing the use of a multi-effect distillation column system for separation of solvent.

FIG. 6 is a schematic showing an embodiment of the precipitation process and system coupled with a membrane ultrafiltration process.

FIG. 7 is a schematic showing an embodiment of the precipitation process and system in conjunction with a membrane process and system.

FIG. 8 is a diagram showing how blockage of membrane pores may be prevented.

FIG. 9 is a schematic comparing flush cycles and membrane recovery in conventional (prior art) membranes versus membranes used in accordance with the principles of the present invention.

FIG. 10 depicts fouling in conventional (prior art) membranes.

FIG. 11 depicts the prevention of fouling in membranes in accordance with the principles of the present invention.

FIG. 12 is a schematic showing an asymmetrical membrane with salt deposition within the membrane due to salt supersaturation conditions occurring within the membrane material.

FIG. 13 is a schematic showing an asymmetrical membrane with salt crystallization occurring outside the membrane as the solvent concentration in the water increases due to selective water permeation through the membrane.

FIG. 14 is a schematic showing a system and apparatus including membranes in accordance with the principles of the present invention.

FIG. 15 is a process flow diagram of one embodiment of a precipitation process and system in accordance with the principles of the present invention.

FIG. 16 is a schematic of a membrane test apparatus.

FIG. 17 is a graph showing superficial velocity of the flow within a membrane cell as a function of volumetric flow rate and spacer heights.

FIG. 18 is an exploded view of a membrane cell.

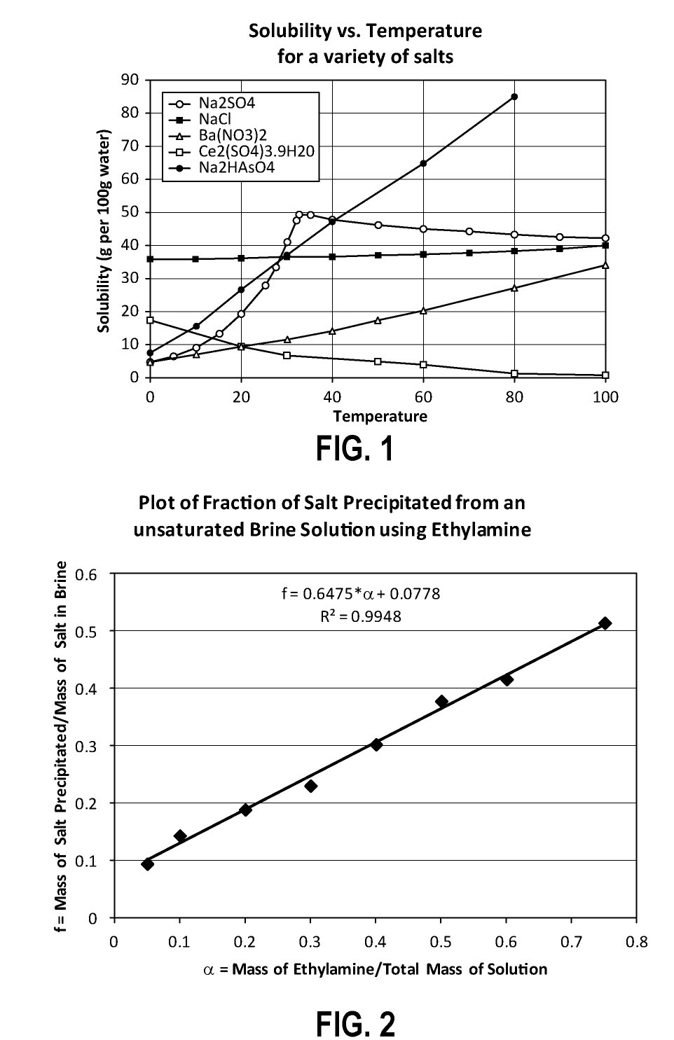

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, the present invention overcomes the issues with removing contaminants such as salts (e.g., sodium chloride) from water (such as flowback water), as described in the Background. It does so, in one aspect, by using a solvent to precipitate the salt out of solution (i.e., out of the water), and by providing apparatus and methods for same. Other aspects of the present invention may include further processing to (1) remove the precipitated salt from the water and (2) remove the solvent from the water. Another aspect of the present invention is that the method and apparatus accomplish this in an efficient, low-energy, and low-cost manner. Additionally, the salt removed may ultimately be converted into higher value products (in order to offset any cost, or portion of the cost, of the water treatment).

Thus, one aspect of the present invention involves precipitating salt out of the water using a solvent. The solvent may be an organic solvent. To that end, ethanol precipitation is a widely used technique to purify or concentrate nucleic acids. In the presence of salt (in particular, monovalent cations such as sodium ions), ethanol efficiently precipitates nucleic acids. Nucleic acids are polar, and a polar solute is very soluble in a highly polar liquid, such as water. However, unlike salt, nucleic acids do not dissociate in water since the intramolecular forces linking nucleotides together are stronger than the intermolecular forces between the nucleic acids and water. Water forms solvation shells through dipole-dipole interactions with nucleic acids, effectively dissolving the nucleic acids in water. The Coulombic attraction force between the positively charged sodium ions and negatively charged phosphate groups in the nucleic acids is unable to overcome the strength of the dipole-dipole interactions responsible for forming the water solvation shells.

The Coulombic Force between the positively charged sodium ions and negatively charged phosphate groups depends on the dielectric constant (∈) of the solution, and is given by the following equation:

$$F = \frac{{q}_{1} {q}_{2}}{4 {πɛ}_{0} {ɛ}_{r} {r}^{2}} = 8.9875 \times {10}^{9} \frac{{q}_{1} {q}_{2}}{{ɛ}_{r} {r}^{2}} newtons$$

Adding a solvent, such as ethanol to a nucleic acid solution in water lowers the dielectric constant, since ethanol has a much lower dielectric constant than water (24 vs 80, respectively). This increases the force of attraction between the sodium ions and phosphate groups in the nucleic acids, thereby allowing the sodium ions to penetrate the water solvation shells, neutralize the phosphate groups and allowing the neutral nucleic acid salts to aggregate and precipitate out of the solution [as described in Pi\check{s}kur, Jure, and Allan Rupprecht, “Aggregated DNA in ethanol solution,” FEBS Letters 375, no. 3 (November 1995): 174-8, and Eickbush, Thomas, and Evangelos N. Moudrianakis, “The compaction of DNA helices into either continuous supercoils or folded-fiber rods and toroids,” Cell 13, no. 2 (February 1978): 295-306, the disclosures of which are incorporated by reference herein in their entireties].

One aspect of the present invention contemplates that the principles regarding the precipitation of nucleic acids via the introduction of water miscible solvents can also be used to precipitate soluble salts, which, like nucleic acids, have solvation shells formed around the ions. Thus, by lowering the dielectric constant of the solution, the Coulombic attraction between the oppositely charged ions can be increased to cause the neutral salts to precipitate out of solution. This general concept has been discussed by Alfassi, Z B, L Ata. “Separation of the system NaCl—NaBr—NaI by Solventing Out from Aqueous Solution,” Separation Sci. and Technol. 18, no. 7 (1983): 593-601, incorporated by reference herein in its entirety, using data on the solubilities of several salts in a mixture of water-miscible organic solvent (MOS), wherein they found that the mass ratio (a) of the water-miscible organic solvent (MOS) to the total mass of aqueous solution (the mass of water plus the mass of solvent dissolved in the water), i.e.,

α=M_{MOS}/M_{Aqueous Solution}

can be correlated against the fraction of salt precipitated from a saturated brine solution, f, as follows:

f=K*α

where K is a precipitation constant. As discussed above, FIG. 2 shows a plot of f versus α for sodium chloride in water using ethylamine as an organic solvent. The actual amount of salt precipitated is f times the mass of salt in a saturated brine solution.

Additionally, if an organic solvent is added to an unsaturated brine solution, then salt precipitation may not begin right away, and there is a minimum amount of solvent needed to begin salt precipitation. This value of α is denoted as αₘᵢₙ, and so the equation “f=K*α” can be rewritten as follows for unsaturated salt solution:

f=αₘᵢₙ+Kα

The value of αₘᵢₙ depends on the concentration of salt in the water. Table 1 (below) shows the value of “f” as a function of α for sodium chloride precipitated from a saturated brine with addition of ethylamine.

TABLE 1
Value of “f” as a function of the α for NaCl precipitated
from a saturated brine with addition of ethylamine.

| alpha | f |
|---|---|
| 0.05 | 0.09469697 |
| 0.1 | 0.143939394 |
| 0.2 | 0.189393939 |
| 0.3 | 0.231060606 |
| 0.4 | 0.303030303 |
| 0.5 | 0.378787879 |
| 0.6 | 0.416666667 |
| 0.75 | 0.515151515 |

While ethylamine is discussed above as being the organic solvent, its use is merely an example, and there are other possible organic solvents (which will cause precipitation of the salt) that can be used instead of ethylamine. These possible solvents include those shown in Table 2 (with the information therein obtained from CRC Handbook of Chemistry and Physics; Organic Solvents by Riddick and Bunger; and Handbook of Solvents by Scheflan and Jacobs).

TABLE 2
Partial List of Organic Solvents that can
be used to precipitate salt from water.

| | Solubility | Heat of | |
|---|---|---|---|
| | in Water | Vaporization | Specific Heat |
| Organic Solvent | (kg/L) | (cal/g) | (cal/g · deg C.) |
| Methylamine | 1.08 | 198.1 | 0.385 |
| Dimethylamine | 3.54 | 140.4 | 0.366 |
| Trimethylamine | 5.5 | 92.7 | 0.371 |
| Ethylamine | Completely | 145.7 | 0.50 |
| Acetaldehyde | Completely | 147.5 | 0.336 |
| Methylformate | 0.23 | 112.4 | 0.478 |
| Isopropylamine | Completely | 109.9 | 0.668 |
| Propylene Oxide | 0.405 | 118.3 | 0.495 |
| Dimethoxymethane | 0.244 | 90.7 | 0.507 |
| t-Butylamine | Completely | 92.8 | 0.628 |
| Propionaldehyde | 0.306 | | 0.522 |
| N-propylamine | Completely | 120.2 | 0.656 |
| Allylamine | Completely | | |
| Diethylamine | 0.449 | 97.5 | 0.577 |
| Acetone | Completely | 119.7 | 0.249 |
| s-Butylamine | Completely | 104.9 | |
| Ethanolamine | Completely | 185.5 | |
| Acetic acid | Completely | 97.1 | |
| Acetonitrile | Completely | | |
| 1,3-Butanediol | Completely | | |
| 1,4 Butanediol | Completely | | |
| Butyric acid | Completely | | |
| Diethanolamine | Completely | | |
| 2-Butoxyethanol | Completely | | |
| Diethylenetriamine | Completely | | |
| Dimethylformamide | Completely | | |
| Dimethoxyethane | Completely | | |
| 1,4-Dioxane | Completely | | |
| Ethanol | Completely | 200 | |
| Ethylene glycol | Completely | | |
| Formic acid | Completely | 115.5 | |
| Furfuryl alcohol | Completely | | |
| Glycerol | Completely | | |
| Methanol | Completely | 263.0 | |
| Methyl | Completely | | |
| diethanolamine | | | |
| 1-Propanol | Completely | | |
| 1,3-Propanediol | Completely | | |
| 1,5-Pentanediol | Completely | | |
| 2-Propanol | Completely | | |
| Propanoic acid | Completely | | |
| Propylene glycol | Completely | | |
| Pyridine | Completely | | |
| Terahydrofuran | Completely | | |
| Triethylene glycol | Completely | | |

One or more of the solvents listed above (or other suitable solvent or solvents), or a combination of solvents, may be used to precipitate salts in accordance with the principles of the present invention. It is within the knowledge of one of ordinary skill in the art to choose which solvent or solvents to use, and such choice may be based on parameters such as the particular liquid or environment (e.g., produced water from fracking, etc.), the salt or salts to be precipitated, etc.

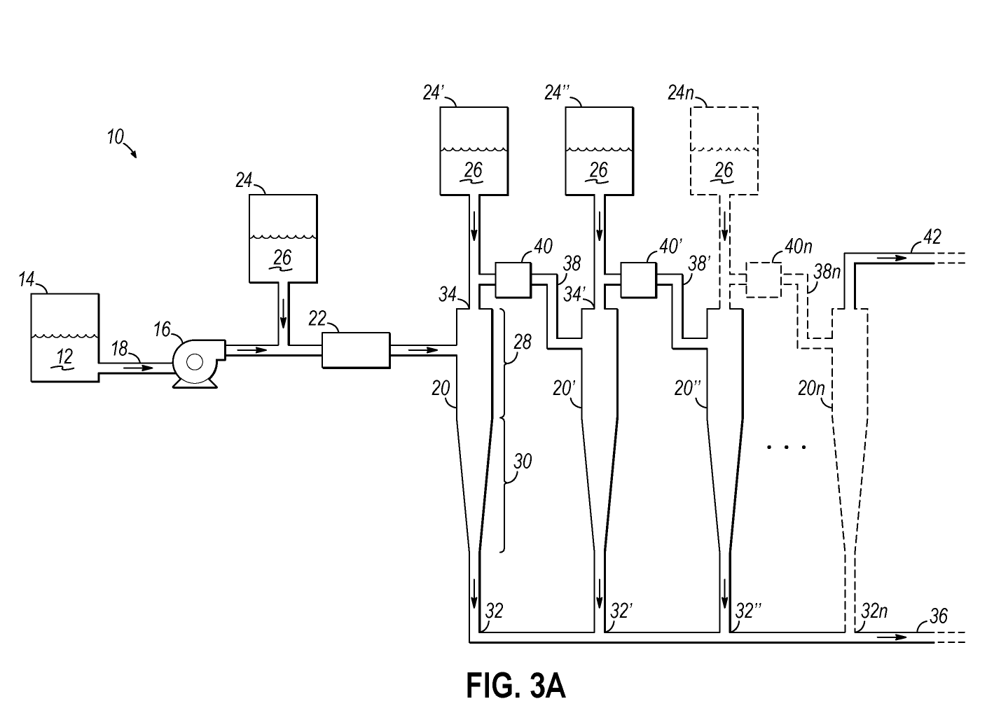

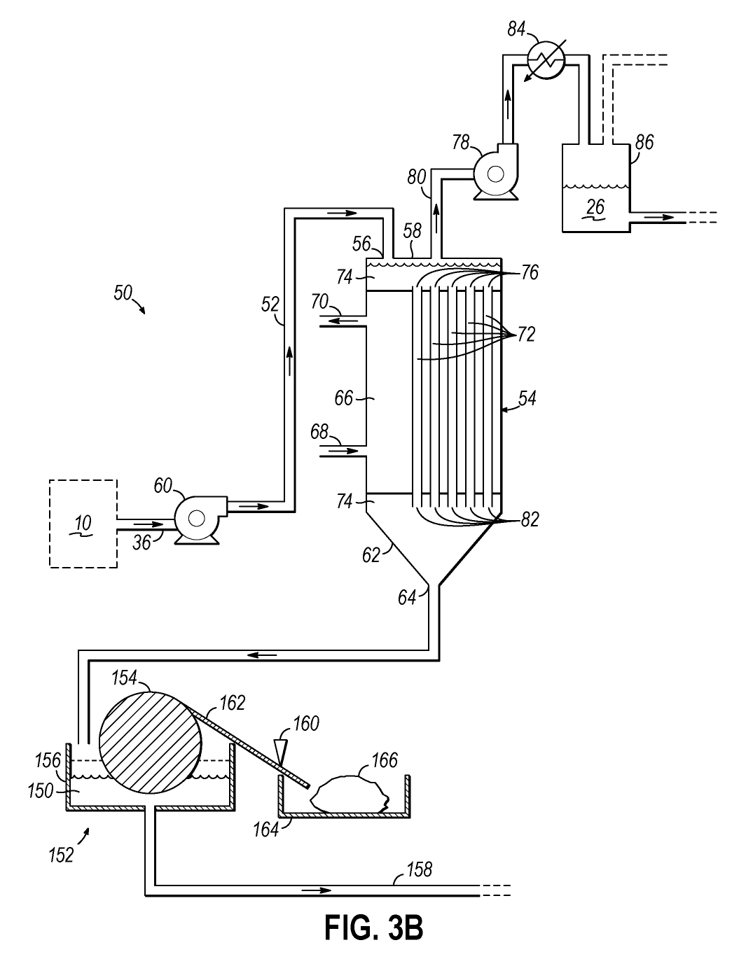

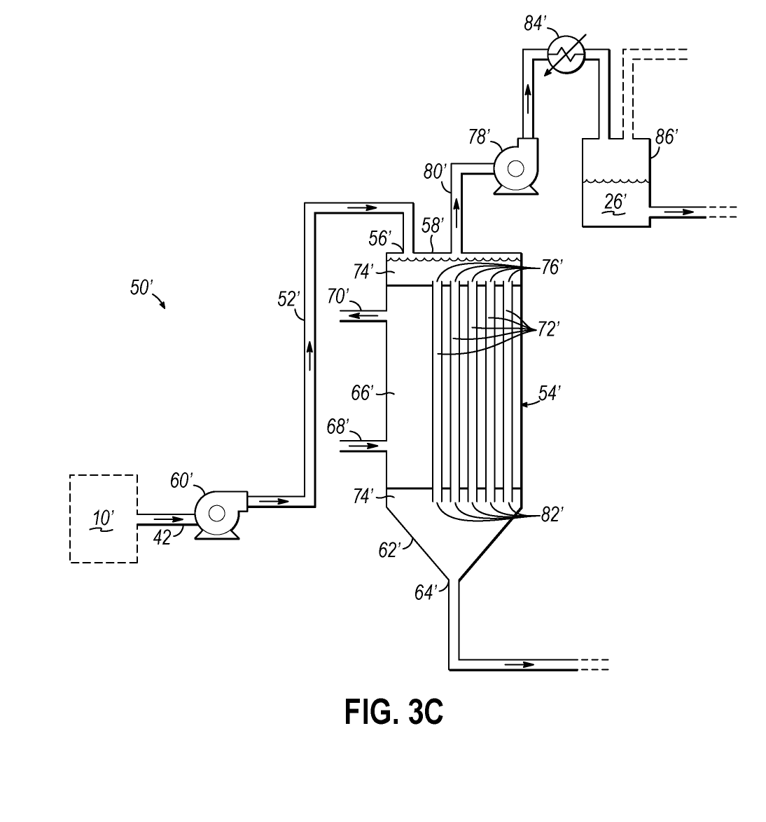

One embodiment of the process (including apparatus) used to precipitate salts via the addition of an organic solvent to solution is shown in FIG. 3A. In general, in this process saline water is mixed with a selected organic solvent, as per the discussion above. In one embodiment, this organic solvent has the following properties: (1) miscible with water; (2) boiling point higher than ambient temperature of 25° C.; (3) low heat of vaporization; and (4) does not form an azeotrope with water. Additionally, the organic solvent may be non-toxic, odorless, and low cost. For example, ethylamine has a low heat of vaporization, as per Table 2, is completely miscible with water in all proportions, has a low dielectric constant and can be easily separated from water (since its boiling point is quite different than water). Those of ordinary skill in the art will recognize that other solvents (or combinations of solvents) may also be useful. For example, the use of membranes to separate solvent from water will be discussed in greater detail below. When using a membrane or membranes for solvent separation, the boiling point differences between the solvent and water are not as important (as when one separates solvent using a vaporization process). Thus, if one were to use a membrane for solvent separation, one could select a larger amine molecule, such as butylamine or even a larger amine molecule, as long as it was miscible with water and had a low dielectric constant. Again, the choice of solvent or solvents is within the knowledge of one of ordinary skill in the art.

In general, once a salt solution (such as water contaminated with one or more salts) and an organic solvent are combined, the use of the solvent will then begin to cause precipitation of salt. As salt begins to precipitate, it may be separated from the solution using at least one hydrocyclone or, as in the illustrated embodiment, multiple hydrocyclones (as will be described in greater detail below). In one embodiment, the ratio (α) of organic solvent added to the salt solution is in the range of 0.05 to 0.3. In a particular embodiment of the present invention, the entire solvent may not be added in one stage. Initially, the amount of solvent added results in salt precipitation, and the salt is separated from the solution using a hydrocyclone. The overflow from this hydrocyclone may then be mixed with more organic solvent to achieve a concentration to make the salt precipitate, which is again separated using a second hydrocyclone. This process of incrementally adding solvent to maintain a solvent concentration for precipitation may be used to precipitate almost 70-95% of the salt from the brine.

Referring to FIG. 3A, a system 10 is shown that includes apparatus suitable for carrying out the methods of the various aspects of the invention. A liquid 12 (such as water), having one or more inorganic salts dissolved therein, such as sodium chloride, magnesium chloride, or calcium chloride, enters from source 14 via pump 16. Path 18 connects the source 14 to at least one hydrocyclone 20. Path 18 includes an in-line mixing apparatus 22. Also connected to path 18, between pump 16 and in-line mixing apparatus 22, is water miscible organic solvent source 24 including solvent 26. Thus, an initial amount of water miscible organic solvent 26, delivered from solvent source 24, is added to water 12 from source 14 in path 18, and the two components are mixed with in-line mixing apparatus 22, resulting in precipitation of some amount of the salt present in the water 12. Path 18 dispenses the mixture into hydrocyclone 20.

Hydrocyclones, in general, are devices that separate particles in a liquid suspension based on the ratio of their centripetal force to fluid resistance. Hydrocyclones generally (and as in the illustrated embodiment) have a cylindrical section 28 at the top where the slurry or suspension is fed tangentially, and a conical base 30. The angle, and hence length of the conical section, plays a role in determining operating characteristics. The hydrocyclone has two exits: a smaller exit 32 on the bottom (underflow) and a larger exit 34 at the top (overflow). The underflow is generally the denser or coarser fraction, while the overflow is the lighter or finer fraction.

Within hydrocyclone 20, a concentrated salt slurry is separated from the aqueous mixture and dispensed at exit point 32 as an underflow. The concentrated salt slurry includes at least water, precipitated salt, and water miscible solvent. The concentrated slurry has a greater amount of precipitated salt than the overflow. The underflow exiting from exit point 32 of hydrocyclone 20 is channeled via pathway 36 to the system shown in FIG. 3B (which will be described in greater detail below). The overflow from hydrocyclone 20 is directed via path 38 to a second hydrocyclone 20′. Path 38 may include an in-line mixing apparatus 40. Also connected to path 38 may be a second water miscible organic solvent source 24′. In some embodiments, source 24 may be used by being also in fluid communication with second hydrocyclone. Thus, an additional amount of water miscible organic solvent 26, delivered from solvent source 24′, is added to the overflow in path 38, and the components are mixed with in-line mixing apparatus 40, resulting in precipitation of an additional amount of the salt present in the water, and the salt is separated from the mixture in hydrocyclone apparatus 20′. A concentrated salt slurry is separated from the mixture in hydrocyclone apparatus 20′ and is dispensed at exit point 32′ as an underflow, which is combined with the underflow from exit point 32 of hydrocyclone 20 and flows via pathway 36 to the system shown in FIG. 3B. Overflow from hydrocyclone 20′ may proceed via path 38′ to a third hydrocyclone 20″. Path 38′ includes in-line mixing apparatus 40′. Also connected to path 38′ is water miscible organic solvent source 24″. In some embodiments, source 24 or source 24′ may be used by being also in fluid communication with second hydrocyclone. Thus, in the illustrated embodiment, an additional amount of water miscible organic solvent 26, delivered from solvent source 24″, is added to the overflow in path 38′, and the components are mixed with in-line mixing apparatus 40′, resulting in precipitation of an additional amount of the salt present in the water, and the salt is separated from the mixture in hydrocyclone apparatus 20″. A concentrated salt slurry is separated from the mixture in hydrocyclone apparatus 20″ and is dispensed at exit point 32″ as an underflow, which is combined with the underflow from exit points 32 and 32′ of hydrocyclones 20 and 20′, respectively, and flows via pathway 36 to the system shown in FIG. 3B.

In this manner, an unlimited number of hydrocyclones 20n are arranged in series, wherein overflows from each of the 20n hydrocyclones proceed along each path 38n to the next hydrocyclone in the series, and in each of the paths 38n, water miscible organic solvent 26 from a source 24n delivers an aliquot of water miscible organic solvent 26 to the path 38n, resulting in precipitation of an additional amount of the salt present in the water. Mixing of the combined flows in each path 38n is accomplished by an in-line mixing apparatus 40n. Salt precipitated by the addition of water miscible organic solvent 26 from each source 24n is separated from the mixture in the corresponding hydrocyclone 20n apparatus. A concentrated salt slurry is dispensed at each exit point 32n as an underflow. The underflow from all exit points 32n of the hydrocyclones 20n is combined; the combined underflow proceeds via pathway 36 to the underflow separation system shown in FIG. 3B. The final separation from the last of the hydrocyclones 20n in the series results in the exiting of a solution of water and water miscible solvent via path 42. In some embodiments, the solution in path 42 is significantly free of salt. In other embodiments, the solution in path 42 is substantially free of salt.

Because the water miscible solvent does not form an azeotrope with water, the water miscible solvent is easily separated from the overflow exiting system 10 via path 42 by the use of conventional methods such as membrane separation or distillation.

In an embodiment including the use of conventional methods such as membrane separation, a certain amount of salt may need to be removed by the series of hydrocyclones so as to prevent fouling of the membranes. (In other words, in such an embodiment, the goal is to achieve a salt concentration which would allow a membrane process to then become technically feasible. For a membrane process to become technically feasible, the osmotic pressure difference across the membrane, in one embodiment, may be less than 1,000 psi. The osmotic pressure difference across the membrane can be calculated as follows:

$$Δ {P}_{Osmostic Press} = [ \frac{( {TDS}_{Feed} + {TDS}_{REject} )}{2} - {TDS}_{Permeate} ] * 0.01$$

where ΔP_{Osmotic Press}=Osmostic Pressure Difference in psi
TDS_{Feed}, TDS_{Reject}, TDS_{Permeate}=Total Dissolved Solids (TDS) in feed, reject, and permeate flows in mg/L

In other embodiments, as will be described later, the particular membrane or membranes, and their particular arrangement and/or use may also serve to prevent membrane fouling.

In other embodiments, anywhere from 50% to 99.9% of the salt may be precipitated out of the overflow water via the present process. The water miscible solvent may thus be available for recycling and can be returned, for example, to a source 24n to be reused in system 10. In some embodiments, the overflow exiting system 10 via path 42 is sent to the system shown in FIG. 3B, or a separate but similar system to that shown in FIG. 3B, such as that shown in FIG. 3C.

It will be understood that the apparatus of the invention employs at least one hydrocyclone, and optionally employs more than one hydrocyclone such as two hydrocyclones, or the three or more hydrocyclones shown in FIG. 3A, or 20n hydrocyclones. How many hydrocyclones are required to carry out effective separation will depend on many factors, including the specific water solution being addressed and the desired total percent separation of salt desired. In some embodiments, between 2 and 20 hydrocyclones are employed. The type of salt, the amount of salt, the presence of more than one species of salt, and the presence of additional dissolved materials within the water phase of the aqueous solution, for example are relevant considerations contributing to the optimized design of the system 10. Variations thereof will be easily envisioned by one of skill.

By employing system 10 and the described separation methodology, a significant amount of salt is separated from the starting solution of inorganic salt in water, when the final water-water miscible solvent mixture that leaves system 10 as overflow is compared to the original solution of inorganic salt in water. For example, in some embodiments, about 50% to 99.9% of the salt is separated from the starting solution of inorganic salt in water, wherein the inorganic salt is separated in the form of the salt slurry. In embodiments, substantially all the salt is separated from the starting solution of inorganic salt in water.

Both the overflow from the final hydrocyclone in the series of hydrocyclones 20n . . . and the combined underflows from each hydrocyclone 20n will contain the organic solvent. The underflows are the separated salt slurry from the aqueous mixture formed by adding the water-miscible solvent to the solution of the inorganic salt in water. The underflows are combined into a single stream that proceeds via path 36 to an underflow separation system. One embodiment of an underflow separation system is shown in FIG. 3B. Herein this separation system may also be referred to as a degassing system. “Degassing” is a term used herein to refer to the process to remove solvent, such as that illustrated in FIG. 3B and FIG. 3C.

Separating Solvent: Vaporization Processes for Solvent Separation

As described above, once salt is precipitated out of solution, another aspect of the present invention involves removing the solvent from the water. In order to minimize the energy for removal of solvent after separation, the use of low-boiling temperature organic solvents is recommended. The energy required to evaporate saturated brine to recover salt is 1505.5 Cal/gm of salt recovered. For ethylamine, however, the amount of energy required to heat brine and ethylamine to the boiling point using an α value of 0.75, (i.e., 75 g of ethylamine for 100 g of saturated brine with 26.4 g of sodium chloride in solution), is 803.5 cal/g of salt precipitated. Hence, the energy ratio of the energy required to vaporize ethylamine per unit weight of salt precipitated to the energy required to vaporize water from brine per unit weight of salt precipitated is 0.53 (803.5/1505.5=0.53). Hence, the energy consumption to obtain salt using the method of the present invention using ethylamine is about half the energy that would have been expended in evaporating water from brine (one of the prior art methods).

Table 3 (below) gives the ratio of the energy needed to evaporate ethylamine to the energy required to evaporate the water. Note that this calculation is approximate since it neglects the sensible heat effects of heating the brine to its boiling point and the sensible heat required to heat the solvent mixture to the boiling point of the solvent. It is estimated that these sensible heat effects will be small compared to the heats of vaporization of the water and solvent.

TABLE 3
Ratio of Energy required to evaporate the Solvent, Ethylamine and
the Energy required to evaporate water from the brine solution.

| alpha | Energy Ratio |
|---|---|
| 0.05 | 0.19 |
| 0.1 | 0.25 |
| 0.2 | 0.39 |
| 0.3 | 0.48 |
| 0.4 | 0.48 |
| 0.5 | 0.48 |
| 0.6 | 0.53 |
| 0.75 | 0.53 |

As noted above, alpha (α) is the ratio of the mass of solvent (in this case, ethylamine) added to the total mass of solution. The energy ratio is minimized when the amount of solvent added is the least, as shown in the table. In other words, the less organic solvent used, i.e., lower the value of alpha, the amount of energy used to evaporate this solvent will also be less, as shown in Table 3.

As will be recognized by those of ordinary skill in the art, both the overflow and underflow of the illustrated embodiment of FIG. 3A will include solvent (the underflow will also include a larger amount of precipitated salt). The combined overflow, from each hydrocyclone, that contains the precipitated salt, is pumped into a degassing system (seen in FIG. 3B), and the overflow from the final hydrocyclone is pumped into a degassing system (seen in FIG. 3C). The apparatus of vessel for underflow and vessel for overflow may be of similar construction (as both are used for separation of solvent). Both the system of FIG. 3B and the system of FIG. 3C may use separator apparatus to remove solvent from underflow and overflow. The separator may include, in one embodiment, a wetted wall tube (such as a wetted wall static separator tube). Further, the separator may be structured to include (a) a housing having at least one wall defining an interior space, an open top end, and an open bottom end, wherein the at least one wall has an inner surface and an outer surface; and (b) a contour disposed on or defined by at least a portion of the inner surface of the at least one wall; and (2) wherein a flow path for an aqueous mixture is provided by at least a portion of the contour and the inner surface of the at least one wall. And, in embodiments where the separator is a wetted wall tube, the tube may include the contour described above.

Underflow

More specifically, and referring to FIG. 3B, a system 50 is shown that includes apparatus suitable for carrying out methods of various aspects of the invention for removal of solvent from underflow. In the embodiment shown in FIG. 3B, system 50 enables the evaporation of the water miscible organic solvent 26 from the slurry, and further enables the optional separation of precipitated salt from the water, wherein one optional means for separating the precipitated salt from the water is shown in FIG. 3B. Underflow from path 36 of FIG. 3A is directed via path 52 of FIG. 3B to the top of evaporation vessel 54, via opening 56 of the enclosed top chamber 58 of vessel 54, aided by pump 60. Vessel 54 includes inlet 56 for the underflow, that is, the incoming salt slurry; top chamber 58; bottom chamber 62; outlet 64 for the concentrated salt slurry; optional jacketed area 66 with inlet 68 and outlet 70 for jacketed temperature control via addition of a heated fluid; and wetted wall separators 72 situated substantially vertically and disposed at least partially within top chamber 58 and bottom chamber 62.

Salt slurry, that is, the underflow 74 in path 36 from a separation system 10 such as that shown in FIG. 3A enters top chamber 58 by flowing along flow path 52 through inlet 56. When the level of underflow 74 in top chamber 58 reaches the level of the top openings 76 of the wetted wall separation tubes 72, it enters and flows down the hollow tubes 72, aided by gravity. As the liquid 74 proceeds down tubes 72, a lower pressure is applied at the top of the tubes 72 by applying a vacuum 78 along path 80 leading from the top chamber 58 of vessel 54. Optionally, instead of applying a vacuum, the lower pressure is applied in some embodiments by forcing an air flow from the bottom openings 82 of tubes 72, disposed within bottom chamber 62 of vessel 54, toward the top openings 76, such as by a blower (not shown). Application of lowered pressure aids in the evaporation of the water miscible solvent from the slurry, and the organic solvent is condensed and collected via path 80 and condensed via condenser 84, and the condensed water miscible solvent 26 is stored in storage tank 86. In some embodiments, this organic solvent is recycled back to the one or more sources such as sources 24n depicted in FIG. 3A, for reuse in a subsequent separation.

Within the vessel 54, the tubes 72 have openings 76 that project into top chamber 58 and openings 82 that project into bottom chamber 62. Between top chamber 58 and bottom chamber 62 of vessel 54, an optional jacketed area 66 surrounds tubes 72; the optional jacketed area 66 has inlet 68 and outlet 70. In some embodiments, a heated fluid is pumped into inlet 68, for example, by a liquid pump or heated gas pump (not shown) and exits via outlet 70. As evaporation occurs within tubes 72, loss of heat of evaporation is mitigated by adding heat to the jacketed area 66.

In some embodiments, the wetted wall separation tubes achieve evaporation of the water-miscible solvent from the salt slurry while maintaining substantial separation of the precipitated salt, that is, preventing subsequent redissolution of the salt in the water as the water miscible solvent is evaporated. This is achieved by a contour feature of the tubes as well as the inner diameter thereof. In embodiments, the wetted wall separator tubes of the invention are characterized primarily by inner diameter defining the inner wall, and height of the tube in combination with the contour feature defining at least a portion of the inner wall.

The rate of evaporation of the water miscible solvent from the salt slurry is determined by both the wetted wall separation tube itself and by additional factors. The tube properties affecting evaporation include the height of the tube, the contour dimensions of the inner wall of the tubes and the portion of the inner wall having the contour feature thereon, and the heat transfer properties of the tube—that is, tube material properties, thickness of the tube, and presence of heat transfer features present on the outer surface of the tube. Additional factors include the heat of vaporization of the water miscible solvent, external temperature control, such as by a jacketed area 66 shown in FIG. 3B, and the amount of pressure differential within the hollow separator tube between the top and bottom of the tube length. The height of the tubes useful in the evaporation is not particularly limited, and will be selected based on the amount of water miscible solvent entrained in the slurry and the heat of evaporation of the water miscible solvent. In some embodiments, the height of the wetted wall separator tubes useful in conjunction with the separation of water miscible solvent from a slurry of sodium chloride in water, using ethylamine as the water miscible solvent, is about 50 cm to 5 meters, or about 100 cm to 3 meters. In embodiments, the portion of the total length of the tube that includes the helical threaded features present on the inner wall thereof is between about 50% and 100% of the total inner wall surface area, or about 90% to 99.9% of the total wall surface area, or about 95% to 99.5% of the total inner wall surface area.

Overflow

More specifically, and referring to FIG. 3C, a system 50′ is shown that includes apparatus suitable for carrying out methods of various aspects of the invention for removal of solvent from overflow. In the embodiment shown in FIG. 3C, system 50′ enables the evaporation of the water miscible organic solvent 26 from the overflow, (and further enables the optional separation of any precipitated salt that may be in the overflow, wherein one optional means for separating the precipitated salt from the water is shown in FIG. 3C). Overflow from path 42 of FIG. 3A is directed via path 52′ of FIG. 3C to the top of evaporation vessel 54′, via opening 56′ of the enclosed top chamber 58′ of vessel 54′, aided by pump 60′. Vessel 54′ includes inlet 56′ for the underflow, that is, the incoming salt slurry; top chamber 58′; bottom chamber 62′; outlet 64′ for the concentrated salt slurry; optional jacketed area 66 with inlet 68′ and outlet 70′ for jacketed temperature control via addition of a heated fluid; and wetted wall separators 72′ situated substantially vertically and disposed at least partially within top chamber 58′ and bottom chamber 62′.

Salt slurry, that is, the overflow in path 42 from a separation system 10 such as that shown in FIG. 3A enters top chamber 58′ by flowing along flow path 52′ through inlet 56′. When the level of overflow in top chamber 58′ reaches the level of the top openings 76′ of the wetted wall separation tubes 72′, it enters and flows down the hollow tubes 72′, aided by gravity. As the liquid 74′ proceeds down tubes 72′, a lower pressure is applied at the top of the tubes 72′ by applying a vacuum 78′ along path 80′ leading from the top chamber 58′ of vessel 54′. Optionally, instead of applying a vacuum, the lower pressure is applied in some embodiments by forcing an air flow from the bottom openings 82′ of tubes 72′, disposed within bottom chamber 62′ of vessel 54′, toward the top openings 76′, such as by a blower (not shown). Application of lowered pressure aids in the evaporation of the water miscible solvent from the slurry, and the organic solvent is condensed and collected via path 80′ and condensed via condenser 84′, and the condensed water miscible solvent 26 is stored in storage tank 86′. In some embodiments, this organic solvent is recycled back to the one or more sources such as sources 24n depicted in FIG. 3A, for reuse in a subsequent separation.

Within the vessel 54′, the tubes 72′ have openings 76′ that project into top chamber 58′ and openings 82′ that project into bottom chamber 62′. Between top chamber 58′ and bottom chamber 62′ of vessel 54′, an optional jacketed area 66′ surrounds tubes 72′; the optional jacketed area 66′ has inlet 68′ and outlet 70′. In some embodiments, a heated fluid is pumped into inlet 68′, for example, by a liquid pump or heated gas pump (not shown) and exits via outlet 70′. As evaporation occurs within tubes 72′, loss of heat of evaporation is mitigated by adding heat to the jacketed area 66′.

In some embodiments, the wetted wall separation tubes achieve evaporation of the water-miscible solvent from the salt slurry while maintaining substantial separation of the precipitated salt, that is, preventing subsequent redissolution of the salt in the water as the water miscible solvent is evaporated. This is achieved by a contour feature of the tubes as well as the inner diameter thereof. In embodiments, the wetted wall separator tubes of the invention are characterized primarily by inner diameter defining the inner wall, and height of the tube in combination with the contour feature defining at least a portion of the inner wall.

The rate of evaporation of the water miscible solvent from the salt slurry is determined by both the wetted wall separation tube itself and by additional factors. The tube properties affecting evaporation include the height of the tube, the contour dimensions of the inner wall of the tubes and the portion of the inner wall having the contour feature thereon, and the heat transfer properties of the tube—that is, tube material properties, thickness of the tube, and presence of heat transfer features present on the outer surface of the tube. Additional factors include the heat of vaporization of the water miscible solvent, external temperature control, such as by a jacketed area 66′ shown in FIG. 3C, and the amount of pressure differential within the hollow separator tube between the top and bottom of the tube length. The height of the tubes useful in the evaporation is not particularly limited, and will be selected based on the amount of water miscible solvent entrained in the slurry and the heat of evaporation of the water miscible solvent. In some embodiments, the height of the wetted wall separator tubes useful in conjunction with the separation of water miscible solvent from a slurry of sodium chloride in water, using ethylamine as the water miscible solvent, is about 50 cm to 5 meters, or about 100 cm to 3 meters. In embodiments, the portion of the total length of the tube that includes the helical threaded features present on the inner wall thereof is between about 50% and 100% of the total inner wall surface area, or about 90% to 99.9% of the total wall surface area, or about 95% to 99.5% of the total inner wall surface area.

Separator Apparatus

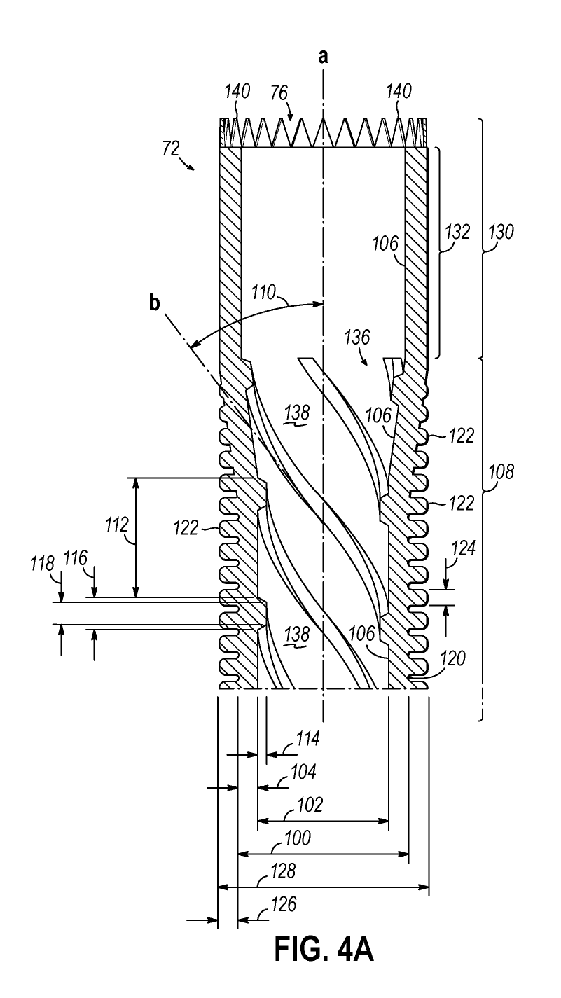

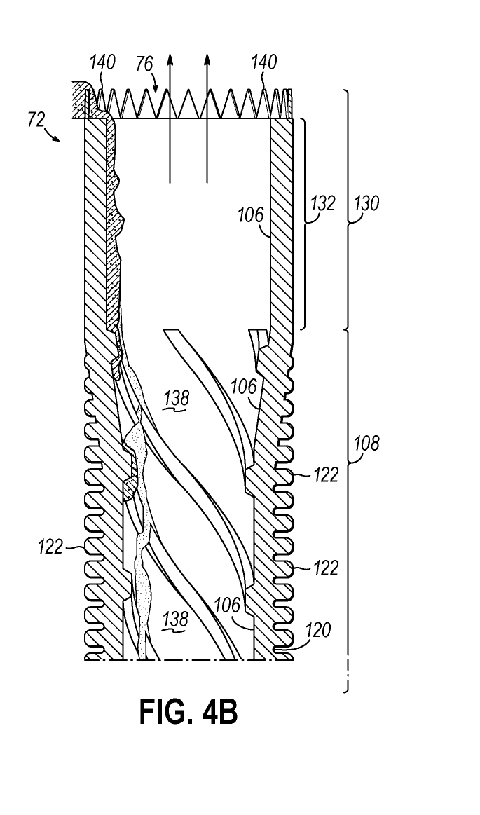

A detail of the apparatus used in the solvent separation process (liquid degassing) is shown in FIGS. 4A and 4B. Liquid degassing is a process in which the liquid containing a low boiling point organic solvent or a dissolved gas is pumped to the top of the degassing system vessel, and the liquid, which may contain a precipitated salt, flows down vertical, high surface area tubes, by gravity. Both the overflow and the underflow liquids (from FIG. 3A) are pumped to the top of such liquid degassing vessels, as shown in FIGS. 3B and 3C. As the liquid flows down the high surface area tubes by gravity, a lower pressure is applied at the top of the tubes using a vacuum pump or even a gas blower. This allows the lower boiling point organic solvent to evaporate out of the water and salt solution, and this organic solvent is condensed and collected in storage tanks. This organic solvent may be recycled back to the in-line mixer 16 (FIG. 3A) to be re-used.

FIGS. 4A and 4B show a schematic detail of the interior and exterior of the high surface area tubes 48, which provide a high surface area between the liquid and gas phases, allowing all the organic solvent to be recovered by evaporation. To assist in this evaporation, some ambient air may be introduced at the bottom of the tubes into the liquid degassing vessels and this air is vented after the condenser, from the organic liquid storage tanks.

The evaporating of solvent contemplates, in some embodiments, the use of a wetted wall separation tube. The tube is in the shape of a hollow cylinder or a pipe, or it can be a hollow frustoconical shape, or a hollow cylinder or a pipe having a frustoconical portion. The tube includes an inner wall and an outer wall wherein a contour, such as a helical threaded feature, defines at least a portion of the inner wall. In some embodiments the helical threads are of substantially the same dimensions throughout the portion of the inner wall where they are located; in other embodiments, helical threads of different dimensions occupy different continuous or discontinuous areas of the tube. In some embodiments, a series of fins defines at least a portion of the outer wall. In some embodiments, the tubes also include one or more weirs proximal to, or spanning, the opening of one end of the tube. In some embodiments, the tubes 48 also include a smooth inner wall portion proximal to one end of the tube.

Further detail regarding the inner and outer wall features of the separation tubes are shown in FIGS. 4A and 4B. FIGS. 4A and 4B are a schematic representation of area of at least one of the tubes 72 shown in FIG. 3B, depicting a section of the length of the tube as indicated, further bisecting the tube in a plane extending lengthwise through the center thereof. The features of FIGS. 4A and 4B are further defined by dimensions represented by lines a, b, and arrow lines 100, 102, 104, 112, 114, 116, 118, 124, 126, and 128 of FIG. 4A. Arrows 100, 102, 104, 112, 114, 116, 118, 124, 126, and 128 of FIG. 4A are used where appropriate to describe the various features and dimensions of the indicated section of wetted wall separation tubes. It will be appreciated that the detailed schematic diagram of FIGS. 4A and 4B are only one of many potential embodiments of the wetted wall separator tubes of the invention. Additional embodiments will be reached by optimization depending on the particular application to be addressed.

Referring to FIGS. 4A and 4B, one embodiment of a wetted wall separation tube 72 is defined by effective outer diameter 100 and effective inner diameter 102 which together define the effective thickness 104 of tube section. For purposes of separating an inorganic salt from water, the tube inner diameter 102 is between about 3 cm and 1.75 cm, or between about 2.5 cm and 1.9 cm. However, for other types of separations, the inner diameter 102 will be optimized to provide the required balance of flow differences between the solid phase and the liquid phase to maintain the solid within the helical grooves and allow the liquid to flow in substantially vertical fashion over the helix ribs when the selected slurry is added to the top opening 76 of wetted wall separation tubes 72. The inner diameter 102 of tube section defines inner wall 106 of tube section. Inner wall 106 includes a helical threaded section 108 defined by helix angle 110 which is defined in turn by lines a, b; helix pitch 112; helix rib height 114; helix base rib width 116, and helix top rib width 118. Helix “land” width is defined as the helix pitch 112 minus helix base rib width 116. Helical threaded section 108 of FIGS. 4A and 4B is further defined for purposes of separating an inorganic salt from water as follows. In embodiments, the helix angle 110 is about 25° to 60° or about 30° to 50°, about 35° to 50°, or even about 38° to 48°. In embodiments, the helix pitch 112 is about 0.25 mm to 2 mm, or about 0.5 mm to 1.75 mm, or about 0.75 mm to 1.50 mm, or about 0.85 mm to 1.27 mm. In embodiments, the helix rib height 114 is about 25 μm to 2 mm, or about 100 μm to 1 mm, or about 200 μm to 500 μm. In some embodiments the helix rib height 114 is about 254 μm. In embodiments, the helix base rib width 116 is about 25 μm to 2 mm, or about 100 μm to 1 mm, or about 200 μm to 500 μm. In embodiments, the helix top rib width 118 is about 0 μm (defining a pointed tip with no “land”) to 2 mm. In some embodiments, helix rib top width 118 is the same or less than helix rib base width 116. In some embodiments, the helix rib profile is triangular or quadrilateral. The helix rib profile shape is triangular in embodiments where helix top rib width 118 is 0; a square or rectangular shape where helix top rib width 118 is the same as the helix base rib width 116; or a trapezoidal shape where helix rib top width 118 is greater than 0 but less than the helix rib base width 116. While helix rib shapes wherein helix rib top width 118 is greater than helix base rib width 116 are within the scope of the invention, in some embodiments, such features are difficult to impart to the interior of a tube such as tubes 72. Further, the helix rib top can be tilted with respect to the approximate plane of the surrounding wall; that is, angled with respect to the vertical plane. Providing a tilted helix rib top will, in some embodiments, increase or decrease the degree of turbulence generated in the flow of the liquid as it proceeds vertically within the tube.

Additionally, while the shape of the helix ribs are not particularly limited and irregular or rounded shapes for example are within the scope of the invention, in embodiments it is advantageous to provide a regular feature in order to maintain laminar flow within the helix land area. Further, in embodiments it is advantageous to provide an angular feature such as a trapezoidal or rectangular feature in order to incur some capillary pressure to maintain the laminar flow within the boundaries of the helix land area. However, it will be recognized by those of skill that machining techniques, such as those employed to machine a helical feature into the interior of a hollow metal tube, necessarily impart some degree of rounding to a feature where angles are intended. As such, in various embodiments the angularity of the features is subject to the method employed to form the helical threaded features that define the inner wall of 10 the wetted wall separation tubes of the invention.

Referring again to FIGS. 4A and 4B, as noted above, the effective outer diameter 100 and effective inner diameter 102 together define the effective thickness 104 of tube section. Effective thickness of the tube is, in various embodiments, about 0.1 mm to 10 mm, or about 0.25 mm to 3 mm, or 0.5 mm to 1 mm where the tube is fabricated from a metal, such as a stainless steel. However, the effective thickness of the tube is selected based on the material from which the tube is fabricated as well as heat transfer properties of the material and other features that will be described in more detail below, and also for convenience. It will be appreciated that an advantage of the wetted wall separator tubes of the invention is that the tubes do not include and are not contacted with moving machine parts, and are not subjected to harsh conditions or large amounts of abrasion, stress, or shear. Therefore, it is not necessary to provide very thick effective wall thickness of the tubes, nor is it necessary to fabricate the tubes from metal, in order to achieve the goal of evaporating the water miscible solvent from the slurry.

Referring again to FIGS. 4A and 4B, the outer diameter 100 of tube section defines outer wall 120 of tube section. Outer wall 120 may include a series of fins 122 protruding from outer wall 120, wherein the fins are defined by fin thickness 124 and fin height 126. The fins are employed in embodiments for temperature control, for example by adding heat via the jacketed area 66 as shown in FIG. 3B, to increase the rate of heat transfer. In some embodiments (not shown), there is land between the fins; in other embodiments the fins do not have land area between them. The purpose of the fins inside the pipe is to break up the liquid flow into smaller streams and create turbulence, which increases the contact surface area between the gas and liquid phases. The purpose of the corrugated fins outside the tube is to increase the surface area between the fluid outside the tubes and the liquid flowing down inside the tubes, so we can heat/cool the liquid effectively.

The shape of the fins are not particularly limited and in various embodiments rounded, angular, rectilinear or irregularly shaped fins are useful. The dimensions of the fins are not particularly limited and are determined by employing conventional heat transfer calculations optimized for the targeted evaporation process. In some embodiments, the fins have fin thickness, or width, 124 of about 0.1 mm to 10 mm, or about 0.5 mm to 5 mm, or about 0.75 mm to 2 mm. In some embodiments, the fins have fin height 126 roughly the same as the fin thickness. The dimension of the fins is incorporated into the total width 128 of the tubes. In some embodiments, instead of fins encircling the tubes, discrete projections protrude from the outer walls in selected locations. In some embodiments, the fins or projections are present over a portion of the outer wall wetted wall separator tubes; in other embodiments the fins or projections are present over the entirety thereof. However, the presence of any fins or projections is optional and in some embodiments fins or projections are unnecessary to achieve effective evaporation of the water miscible solvent.

An additional optional feature of the wetted wall separator tubes of the invention includes an entry section proximal to the top openings of the tubes that facilitates and establishes a suitable flow of the slurry entering the tube. The entry section 130 includes the top opening 76 and a first portion 132 of the inner wall 134 of the tube. A suitable flow is created when slurry enters the tube in a volume and flow pattern enter the helical threaded portion 136 of the tube in a manner wherein the solids tend to enter the helical threaded area beneath the entry section and flow in laminar fashion within the land area 138 between the helix ribs, and the bulk of the liquid phase tends to flow substantially vertically within the tube, further wherein the vertical flow is turbulent by virtue of passing over the helix rib features. The design of the entry section will vary depending on the nature of the slurry as well as the design of the helical thread situated further along the tube as the slurry proceeds vertically. For separation of a slurry of sodium chloride, we have found that the entry section optionally includes weirs 140 proximal to the top opening, and a smooth inner wall 134 extending from the top opening 76 to the onset of the helical threaded portion 136 of the tube. The weirs are designed to provide a substantially laminar flow of slurry at a suitable volume for flowing across and into the helical threaded area of the inner wall of the tube. In some embodiments, the weirs are rounded features, such as o-ring shaped features, placed proximal to and above the top opening, that facilitate slurry flow into the tube such that the flow proceeds in contact with the inner wall thereof. In other embodiments, the weirs are a series of walls, slotted features, or perforated openings disposed above and extended across the top opening, and shaped to provide flow of the slurry into the tube such that the flow proceeds in contact with the inner wall thereof. In some such embodiments, the weirs also regulate the rate of flow into the tube. The weirs are formed from the same or a different material or blend of materials than the tube itself, without limitation and for ease of manufacture, provision of a selected surface energy, or both.

In embodiments, the weirs are followed, in a portion of the tube proximal to and below the top opening, by a smooth inner wall section. The smooth inner wall section is characterized by a lack of a helical threaded feature or any other feature that causes disruption of the slurry in establishing a laminar downward flow within the tube. In embodiments, the smooth inner wall section extends vertically from the top opening of the tube to about 0.5 mm to 10 mm from the top opening of the tube, or about 1 mm to 5 mm from the top opening of the tube. Proximal to the smooth inner wall section in the vertical downward direction, the helical threaded portion of the inner wall begins. In some embodiments the smooth inner wall section has a substantially cylindrical shape; in other embodiments it has a frustoconical shape; that is, the smooth inner wall of the tube is frustoconical leading to the helical threaded inner wall portion. The frustoconical shape is not necessarily mirrored on the outer wall of the tube, though in embodiments it is. In general, where the smooth inner wall section has a frustoconical shape, the conical angle is about 1° to 10° from the vertical.

It will be understood that the fins 122 on the outer wall of the wetted wall separator tubes, as shown in FIGS. 4A and 4B, weirs, and a smooth inner wall section are optional features, and that the only feature necessary to the wetted wall separator tubes of the invention are the basic hollow cylinder or frustoconical shape having an inner wall and an outer wall wherein a helical threaded feature defines at least a portion of the inner wall. In embodiments, the helical threaded feature extends over a significant portion of the inner wall, and in other embodiments the helical threaded feature extends over substantially the entirety of the inner wall. In still other embodiments, the helical threaded feature extends over substantially the entirety of the inner wall except for the smooth inner wall portion of the tube as described above.

In the evaporation systems of the invention, such as the system 50 shown in FIG. 3B, there is at least one wetted wall separation tube 72. The number of tubes employed, in an array of tubes contained within an evaporation apparatus, is not limited and is dictated by the rate of delivery of slurry into the apparatus. In some embodiments, an evaporation apparatus of the invention includes between 2 and 2000 wetted wall separation tubes, disposed substantially vertically and parallel to each other and having the top openings 76 substantially in the same plane. In some embodiments where two or more tubes are present in an evaporation apparatus, the tubes are placed far enough apart from one another to provide for efficient heat transfer with the surrounding environment; where a jacketed area surrounds the tubes this spacing must account for efficient flow of the heat transfer fluid around and between the tubes. It will be appreciated that the number of tubes present in a particular evaporation apparatus of the invention will be adjusted based on the selected flow rate of slurry delivered by the precipitation apparatus such as the apparatus of FIG. 3A. In some embodiments, more than one evaporation apparatus 54 is connected to path 52, or chamber 58 is split into two or more chambers, in order to address total flow of slurry from flow path 52 into the tubes 72. Such compartmentalized control is useful because tubes 72 have a range of flow operability, that is, a minimum and a maximum flow capacity wherein turbulent wetted wall flow is achieved. Higher flow rates from flow path 52 require the use of more tubes, once the maximum flow capacity of one tube or one group of tubes is reached.

The wetted wall separation tubes of the invention are not particularly limited as to the materials used to form them. Layered or laminated materials, blends of materials, and the like are useful in various embodiments to form the wetted wall separation tubes of the invention. Materials that form the inner wall and thus the helical threaded features are selected for machining or molding capability, imperviousness to the materials to be contacted with the inner wall, durability to abrasion from the particulates in the slurries contacted with the inner wall, heat transfer properties, and surface energy of the material selected relative to the surface tension of the slurry to be contacted with the inner wall. In various embodiments, the wetted wall separator tubes of the invention are formed from metal, thermoplastic, thermoset, ceramic or glass materials as determined by the particular use and temperatures encountered. Metal materials that are useful are not particularly limited but include, in embodiments, single metals such as aluminum or titanium, alloys such as stainless steel or chrome, multilayered metal composites, and the like. It is important to select a metal for the inner wall of the tubes that is impervious to water, salt water, or the selected water miscible solvent. In some embodiments, metals have the additional advantage of providing excellent heat transfer, and so are the material of choice. In some embodiments, stainless steel is a suitable material for use in conjunction with the separation of sodium chloride from water. In some embodiments, it is advantageous to employ thermoplastic materials as part of, or as the entire composition of the tubes due to ease of machining or to minimize cost, or both. Further, in embodiments thermoplastics may be molded around a helically-shaped template and the helical threaded features imparted to the molded tubes are, in some embodiments, more defect-free than their metal counterparts. However, a thermoplastic selected to compose the inner wall of the tube must be substantially impervious to any effects of swelling or dissolution by water, salt water, or the selected water miscible solvent and substantially durable to the abrasion provided by movement of slurry particles within the tubes. Examples of suitable thermoplastics for some applications include polyimides, polyesters, polycarbonate, polyurethanes, polyvinylchloride, fluoropolymers, chlorofluoropolymers, polymethylmethacrylate, polyolefins, copolymers or blends thereof, and the like. The thermoplastics further include, in some embodiments, fillers or other additives that modify the material properties in a way that is advantageous to the overall properties of the tube, such as by increasing abrasion resistance, increasing heat resistance, raising the modulus, or the like. Thermosets are typically crosslinked thermoplastics wherein the crosslinking provides additional dimensional stability during e.g. temperature changes or any tendency of the polymer to dissolve or degrade in the presence of water, salt water, or the selected water miscible solvent. Radiation crosslinked polyolefins, for example, are suitable for some applications to form the inner wall or the entirety of a wetted wall separation tube of the invention. Ceramic or glass materials are also useful materials from which to form the wetted wall separation tubes of the invention and are easily machined to high precision in some embodiments.

The wetted wall separation tubes are particularly well suited for providing a means for evaporating the water miscible organic solvent from the salt slurry formed using the methods of the invention. It is an advantage of the wetted wall separation tubes that no moving parts reside within the tubes; and that the tubes are of simple design; and that the tubes contain no features that tend to collect and/or aggregate the slurry particles. The evaporation of the water miscible solvent is highly efficient using the wetted wall separation tubes of the invention, and the solid slurries particles are able to proceed in unfettered fashion downward through the tube. The wetted wall separation tubes provide a high surface area between the liquid and gas phases, allowing substantially all of the water miscible solvent to be recovered by evaporation and resulting in an overall efficient and rapid evaporation process. Because the salt crystals formed during the fractional addition of the water miscible solvent are small, they can be carried down the tubes along with some amount of liquid, in some embodiments in a substantially laminar flow that follows the helical threaded pathway.

Referring once again to FIG. 3B, after evaporation from the wetted wall separation tubes 72, a concentrated salt slurry 150 exits tubes 72 at bottom openings 82 thereof. The precipitated salt and water, now substantially free of water miscible solvent, flow into bottom chamber 62 and exit outlet 64 as a concentrated salt slurry. In some embodiments, the salt crystals have been subjected to substantially laminar flow and do not tend to redissolve in the water as the water miscible solvent is removed from the turbulent flow. Thus, the crystals are easily isolated from the concentrated salt slurry exiting tubes 72 at bottom openings 82. The concentrated salt slurry is deposited into a collection apparatus 152. Collection apparatus 152 as shown is the same or similar to cylinder formers developed for papermaking applications, as will be appreciated by those of skill. Cylinder former 152 includes a horizontally situated cylinder 154 with a wire, fabric, or plastic cloth or scrim surface that rotates in a vat 156 containing the concentrated salt slurry 150 delivered from exit outlet 64. Water associated with the slurry 150 is drained through the cylinder 154 and a layer of precipitated salt is deposited on the wire or cloth, and exits collection apparatus 152 via pathway 158. The drainage rate, in some designs, is determined by the slurry concentration and treated water level inside the cylinder such that a pressure differential is formed. As the cylinder 154 turns and water is drained from the slurry, the precipitate layer that is deposited on the cylinder is peeled or scraped off of the wire or cloth, such as with a scraper blade 160 or some other apparatus, and continuously transferred, such as via a belt 162 or other apparatus, to receptacle 164. In some embodiments, during transport of the deposited layer of salt 166 to the receptacle 164, the salt is dried, such as by applying a hot air knife (not shown) across the belt 162 or by heating belt 162 directly, or by some other conventional means of drying salt crystals.

In some embodiments, water exiting collection apparatus 152 via pathway 158 may be sent to a subsequent treatment apparatus, such as ultrafiltration or nanofiltration, in order to remove the remaining salt or another impurity.

In some embodiments, the tubes are surrounded by a source of heat 66 to aid in the evaporation. In some embodiments, the water miscible organic solvent is collected by providing a condenser or other means of trapping the evaporated solvent that exits the top of the wetted wall separator tubes due to the flow of gas upward through the tubes. The evaporated solvent is significantly free, or substantially free, of evaporated water, which enables the isolation of sufficiently pure solvent. The ability to collect the water miscible solvent enables the solvent to be incorporated in a closed system of solvent recycling within the overall precipitation and evaporation process.

It will be appreciated that depending on the type of gas-liquid-solid separation to be carried out, the ratio of liquid to solid in the slurry, and the flow rate selected for the slurry through the tube, the inner diameter of the tube, the helix angle of the helical thread, and the dimensions of the helical features will necessarily be different in order to effect the most efficient separation.

The liquid degassing vessel is one method to achieve a high surface area between the gas and liquid phases. Other methods that could be used is a packed tower, with packing to increase the contact surface area between the gas and liquid phases, or even a spray tower in which the liquid is sprayed in the form of small droplets into the gas phase, which is maintained at a lower pressure. The low boiling point solvent would then transfer from the liquid to the gas phase.

Degas sing of the organic solvent means that the organic solvent should have a low boiling point and preferably a low heat of vaporization. However, the energy of vaporization needs to be supplied in order to convert the organic to the vapor state and remove it from the liquid water phase. In order to achieve a high removal efficiency for the organic, the boiling point difference between the organic and water should be as large as possible. Hence, some of the possible organics listed in Table 2 have a low boiling point when compared to water.

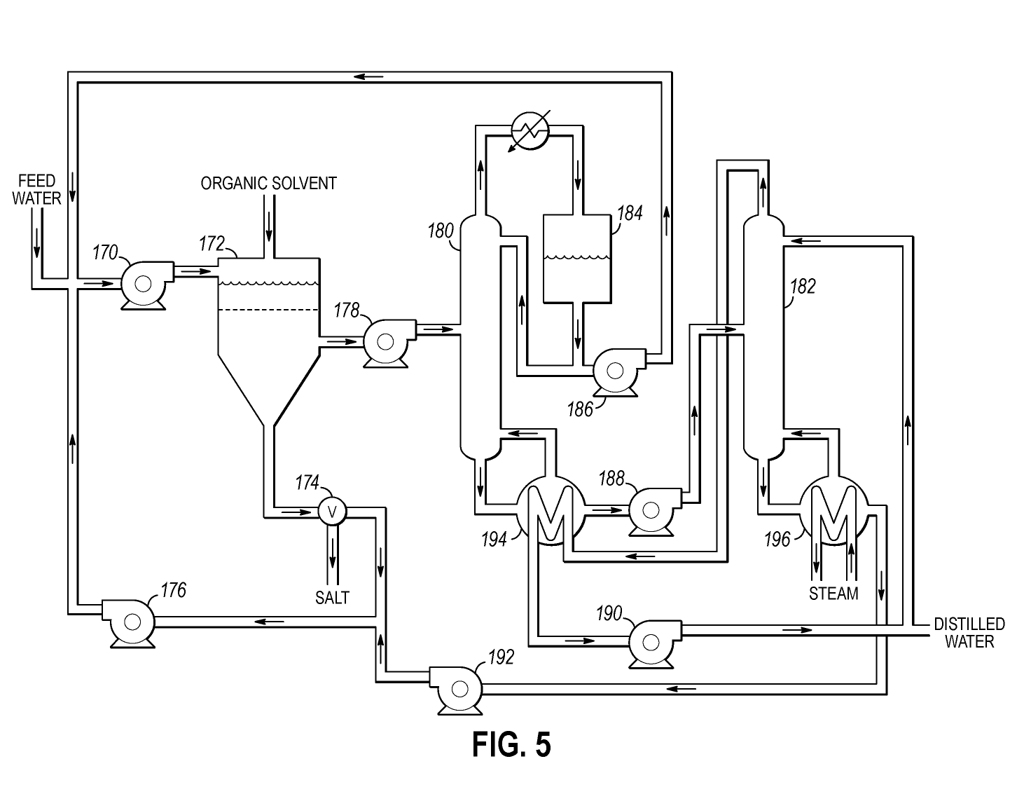

If the boiling point of the organic solvent and water are not very different, a multi-effect distillation column can be used to separate the organic from the water and achieve a high degree of separation for the solvent. As is known to those of ordinary skill in the art, multi-effect distillation is a distillation process that includes multiple stages. In each stage, the feed liquid (e.g., water) is heated (such as by steam) in tubes. Some of the liquid evaporates, and this steam flows into the tubes of the next stage, heating and evaporating more liquid. Each stage essentially reuses the energy from the previous stage. FIG. 5 shows an example of a multi-effect distillation column in which organic solvent is separated using two distillation columns operating at two different pressures. In this embodiment, one column operates at a higher pressure than the other column, and in the higher pressure column, the temperature of the condenser is higher than the temperature of the reboiler, which allows the heat evolved by the condensation of the vapors to be used to reboil the liquid in the reboiler.

More specifically, and referring to FIG. 5, the feed water, containing salts (monovalent, divalent, etc.), enter into feed pump 170 and then flows into settler vessel 172. The feed water may be any water prior to any contact with solvent—and as can be seen from the figure, and as will be described in greater detail below, the feed water will mix (in the illustrated embodiment) with recovered streams containing solvent. Additional solvent is added to the vessel 172 also, to make up any loss of organic solvent(. Such loss occurs, for example because any liquid removed from the settler vessel will likely include some amount of solvent, and so to maintain the amount of solvent in the vessel, the solvent needs to be replenished. In the settler vessel 172, some of the divalent and monovalent salts are precipitated (due to the presence of solvent), and the resulting slurry of water and precipitated salts is removed through valve 174. Alternatively or additionally, some of this precipitated salt and water is recycled back to the starting point (i.e., feed point) using the recycle pump 176, where it is again directed into the settler vessel 172 via feed pump 170. The salt crystals that are present in this recycled slurry (of water and precipitated salt) assist in nucleating further salts (divalent, monovalent, etc.) from further incoming feed water, which promotes greater growth of salt crystals (upon solvent-induced precipitation from the feed water), which in turn promotes faster settling of precipitated salt in the settler, due to the increased crystal size.

The more clear portion of water from the settler, i.e., that portion having a lower concentration of salts (divalent, monovalent, etc.), will be located nearer to the top of the body of liquid in the tank 172, since the salt crystals will generally sink toward the bottom of the tank 172 (as described above). Thus, this more clear portion of water may be pumped by pump 178 into a first distillation column 180 (for removal of solvent), which may be set to operate at a lower pressure than a second distillation column 182. The organic solvent is removed as a pure compound or as a azeotropic composition with water as the top product, which is condensed, and collected in overhead product drum 184. A portion of the recovered solvent may then be returned back to the top of the first distillation column 180 as reflux, and the remaining portion may be recycled back to the settler tank 172 using pump 186. In this manner the organic solvent is recovered and recycled back to the settler 172 to precipitate more salt from the feed water.

The bottom product, (i.e., the portion that exits the bottom of the first distillation column 180) containing salts and water, may be partially reboiled back as water vapor (via the use of first heat exchanger 194) and returned back to the bottom of this distillation column. The remaining portion of this bottom product may be withdrawn by pump 168 and fed into the second distillation column 182, which operates at a higher pressure than the first distillation column 180. The reason for operating the second distillation column 182 at a higher pressure than the first distillation column 180 is due to the fact that at a higher pressure, the boiling point (condensing temperature) of the pure water, produced in the top product of distillation column 182, will be higher than the boiling point of the bottom product of the first distillation column 180, and thereby the heat of condensation of water vapor exiting the top of second distillation column 182 can be used to partially vaporize the bottom product of first distillation column 180 (as shown in FIG. 5). This allows heat integration of the two distillation columns to minimize the net energy consumption within this process. The second distillation column 182 is operated at a pressure such that this heat transfer can occur economically with a reasonable temperature driving force and heat exchanger area.

The top product of second distillation column 182 is pure water, with no salt, and this water is pumped by pump 190 as the distilled water product. The bottom product of distillation column 182 includes mainly salt water. A portion of this bottom product may be partially reboiled back as water vapor (via the use of second heat exchanger 196) and returned back to the bottom of the second distillation column 182. The remaining portion of this salt water is pumped by pump 192 back to the settler to allow more salt to be precipitated.

By using the two distillation columns with heat integration, achieved by operating the second column 182 at a higher pressure than distillation column 180, the organic solvent is recovered and recycled back and salt is continuously precipitated from the feed water. The salt slurry produced from the bottom of the settler can be further filtered, (filter not shown in FIG. 5), and the salt water, once separated from the wet salt, can also be recycled back to the settler.

Alternate Solvent Separation Methods

Apart from the evaporation processes described above, other methods of separation of solvent may use non-vaporization processes to separate the organic solvent from the salt water solution.

One such separation method which does not require any vaporization of the solvent is a membrane process, in which the solvent is separated from the water using either a porous membrane, such as ultrafiltration or nanofiltration, or a dense membrane process, such as reverse osmosis. Thus, in various aspects and embodiments, the methods and apparatus of the present invention may use only one of these types of membranes, or any combination of these types of membranes. For effective membrane separation of the solvent from the water, a suitable membrane has to be used, i.e., one which can reject the solvent molecules and allow water (pure or salt water) to pass through. Of course, if a non-vaporization method is being used to separate the organic solvent from the water, then the energy ratio calculated in the above Table 3 is no longer applicable, since the energy ratio assumed that the solvent was going to be evaporated. However, in a membrane process using a dense membrane film, such as reverse osmosis, the osmotic pressure exerted by the solvent needs to be accounted for, and since a higher molecular weight solvent will exert a lower osmotic pressure than a lower molecular weight solvent, a higher molecular weight solvent may be useful in certain embodiments (as opposed to a lower weight solvent), such as where the concentrations of the two solvents would be the same (or similar) to achieve the same extent of salt separation. Further, in certain embodiments, a higher molecular weight solvent may have greater potential to be separated and recycled back using ultrafiltration and/or nanofiltration, which have much lower operating pressure membranes than reverse osmosis (due to the more dense nature of the reverse osmosis membranes). Thus, in certain embodiments, the choice of solvent and membranes may further reduce the energy expenditure required.

As described above, any organic solvent that is miscible in water and changes the dielectric constant of the water solution to some extent can be used to cause salt precipitation to occur. In general, if the solvent has a large molecular weight then it can be separated from water using a reverse osmosis or even an ultrafiltration or nanofiltration membrane. In other words, larger molecules, depending on molecular weight would be rejected by the membrane, while water would pass through the membrane. As will be recognized by those of ordinary skill in the art, the larger the solvent molecule, the easier it is to remove it from the salt water using membranes. On the lower end, if distillation columns are being used, as in FIG. 5, then the solvent molecule can be small since then it can be easily boiled at a lower temperature. The rejected organic solvent can then be recycled back for reuse to precipitate more salt from the water.

Another embodiment of the present invention may use a reverse osmosis or a nanofiltration membrane to concentrate the salt in water to achieve almost a saturated salt in water condition in the membrane reject stream (i.e., before the addition of any solvent). Then the solvent precipitation process can be used for this salt-concentrated reject stream to precipitate the salt from the water.

Further, as will be described in greater detail below, when using membranes for separation, a concern is always the extent to which (and the rapidity with which) the membranes may become fouled (e.g., clogged) to an extent that reduces their effectiveness such that they must be cleaned or replaced. Any time membranes must be cleaned or replaced, the system containing those membranes experiences down time, which is not cost efficient. As will be described in greater detail below, a further aspect of the present invention provides embodiments of separation systems using membranes that greatly reduce or eliminate the amount of membrane fouling. In certain embodiments, the methods and apparatus of the present invention may be used to prevent fouling or clean membranes during salt and solvent separation.

As described above, membranes that may be used in various aspects and embodiments of the present invention include ultrafiltration, nanofiltration, and reverse osmosis. Each of these will be described in greater detail below.

Ultrafiltration

Ultrafiltration is a variety of membrane filtration in which hydrostatic pressure forces a liquid against a semipermeable membrane. Suspended solids and solutes of high molecular weight are retained, while water and low molecular weight solutes pass through the membrane. Ultrafiltration is not fundamentally different from nanofiltration except in terms of the size of the molecules it retains.

The objective of ultrafiltration is to remove any particulates that may be present in the water while allowing all soluble species to get through the membrane. One of the main challenges in ultrafiltration is to maintain a high flux of water through the membrane, while minimizing the buildup of particulates on the membrane surface (i.e., prevention of membrane fouling (as described above).

Ultrafiltration can be conducted using several membrane configurations, including: (1) hollow fiber membranes, (2) spiral wound membranes, (3) flat sheet membranes, and (4) tubular membranes. Hollow fiber membranes include several hundred fibers installed within a cylindrical shell such that the feed water permeates through the membrane to the inside of the fibers. The particulates stay outside the fibers, and periodically through back-flushing and use of air and chemicals, the deposited particulates on the membrane surface are taken off the membrane surface and flushed away with the reject stream. In spiral wound membranes, flat membrane sheets are wound into a spiral, and spacers are used to separate the feed water from the permeate. Flat sheet membranes are installed as parallel sheets and have spacers to separate the feed water from the permeate. And tubular membranes, which are larger diameter tubes installed within a shell, operate much like the hollow fibers, except the tubes are longer and the number of tubes is (e.g., in the tens rather in the hundreds).

Of all the membrane configurations, hollow fibers are the most compact with the highest surface area per unit volume. However, since the particulates are deposited outside the hollow fibers, and there are several hundred and even thousands of these very small diameter hollow fibers installed within a small diameter cylindrical shell, the particulates get caught within the fibers and are difficult to dislodge from the outside of the fibers. Spiral wound membranes have a very narrow space between the spirally wound flat sheets, since the spacers are thin, and this causes the spaces between the flat sheets to get clogged with particulates easily. Flat sheet membranes are easier to clean, but have a large number of gaskets, with one gasket between each sheet and the membrane modules are not compact. Of all the membrane configurations, tubular membranes are perhaps the easiest to clean any particulate deposits off the membrane surface, though typical uses of tubular membranes will still result in membrane fouling. These various characteristics may be used by one of ordinary skill in the art to determine which membrane type to use in various embodiments of the present invention. One embodiment of the invention may use spiral wound membranes, for example.

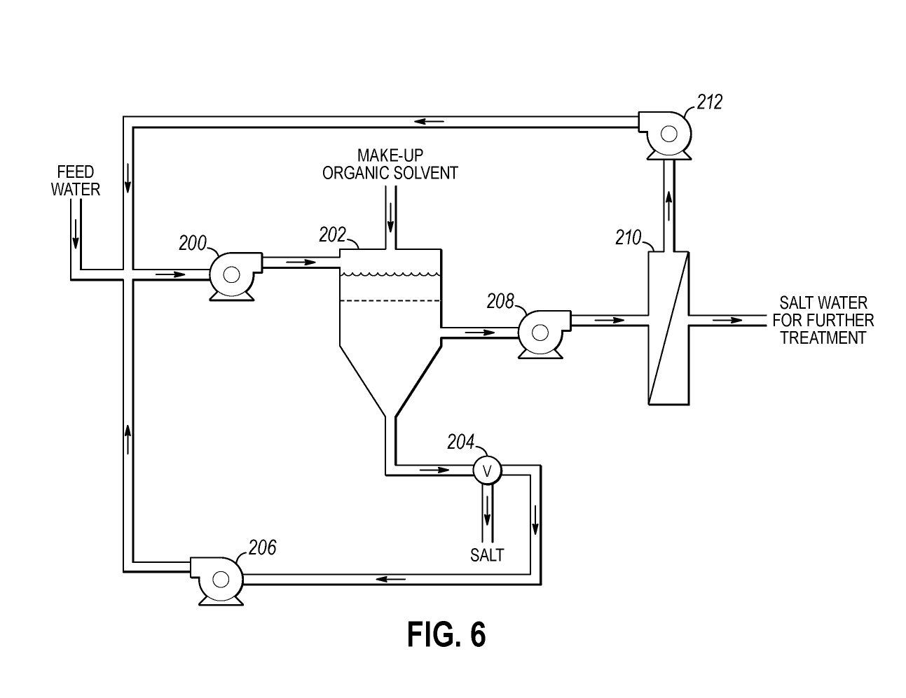

With reference to FIG. 6, the following is a description of an example of one possible embodiment of use of ultrafiltration to recover solvent following salt precipitation. As described above, if the organic molecule has a high molecular weight, such as a sugar, then a simple ultrafiltration membrane can be used to recover the solvent. The high TDS feed water is pumped by the feed pump 200 into the settler 202, wherein it mixes with the organic solvent, which results in the precipitation of salts, BOD, COD, etc. The settled solids are taken out from the bottom of the settler and the solid slurry is sent to a filter, not shown in FIG. 6, by a valve 204, Some of this solid slurry is diverted by the valve 204 into the recycle pump 206, which returns this slurry back to the inlet of the settler. The objective of recycling this solid slurry is that the precipitated salt crystals serve as nucleation sites for further crystal growth, and this allows the larger salt crystals to precipitate faster in the settler. The clear liquid from the settler is pumped by the pump 208 into a membrane unit, which is capable of separating the organic solvent from the salt water. If the organic solvent is a high molecular weight organic, such as sugar, then the membrane unit 210 can be an Ultrafiltration membrane unit, and this would allow the organic solvent to be separated at lower operating pressures than if a nanofiltration membrane or even a reverse osmosis membrane had to be used. The salt water passes through the membrane and is further treated to remove the salt using other membrane units, such as nanofiltration and/or reverse osmosis, not shown in FIG. 6. The organic solvent separated by the membrane unit 210 is simply recycled back to the settler.

More specifically, and referring to FIG. 6, the feed water, containing salts (monovalent, divalent, etc.), enter into feed pump 200 and then flows into settler vessel 202. (Additional solvent is added to the vessel 202 also, to make up any loss of organic solvent. This make-up solvent is to make up for solvent losses when the salt slurry is sent to the filter, not shown in FIG. 6, wherein the wet salt is separated from the salt water, which is returned back to the settler. In the settler vessel 202, some of the divalent and monovalent salts are precipitated (due to the presence of solvent), and the resulting slurry of water and precipitated salts is removed through valve 204. Alternatively or additionally, some of this precipitated salt and water is recycled back to the starting point (i.e., feed point) using the recycle pump 206, where it is again directed into the settler vessel 202 via feed pump 200. The salt crystals that are present in this recycled slurry (of water and precipitated salt) assist in nucleating further salts (divalent, monovalent, etc.) from further incoming feed water, which promotes greater growth of salt crystals (upon solvent-induced precipitation from the feed water), which in turn promotes faster settling of precipitated salt in the settler, due to the increased crystal size.

The more clear portion of water from the settler 202, i.e., that portion having a lower concentration of salts (divalent, monovalent, etc.), will be located nearer to the top of the body of liquid in the tank 202, since the salt crystals will generally sink toward the bottom of the tank 202 (as described above). Thus, this more clear portion of water may be pumped by pump 208 to an ultrafiltration membrane 210 (for removal of solvent). The organic solvent is removed as it cannot pass through the membrane, and so the rejected solvent may be directed via pump 212 to be recycled back to the settler tank 202. In this manner the organic solvent is recovered and recycled back to the settler 202 to precipitate more salt from the feed water.

Thus, the solvent separated by the ultrafiltration membrane in FIG. 6 can be recycled back for reuse and the salt water that passes through the ultrafiltration membrane may then be further treated using a nanofiltration process or reverse osmosis process or combined nanofiltration/reverse osmosis process. One benefit of the above-described solvent precipitation process is to reduce the salt concentration in the feed water, which will further reduce the osmotic pressure needed to use nanofiltration/reverse osmosis membranes to subsequently purify the water. The reject streams from the nanofiltration/reverse osmosis membranes containing solvent, can all be recycled back to the inlet of the solvent precipitation process, to again be used to precipitate salts from incoming water (or other liquid).

Further, as described above, in previously used membrane processes, problems arise with fouling of the membranes. Previously used strategies to keep the membrane surface clean include (1) air injection, which helps in dislodging any deposits off the membrane surface without causing any harm to the membrane surface, (2) back-pulsing by forcing the permeate backwards through the membrane into the feed side, while interrupting the feed flow, to dislodge any particulates deposited on the membrane pores, and (3) chemicals, such as citric acid to loosen any deposits on the membrane surface. However, there are drawbacks to each of these methods. For example, back-pulsing and chemical cleaning requires the use of several control valves, which have to open and close in order to isolate the membrane module temporarily for cleaning, so that the cleaning chemicals or the permeate do not mix with the feed flow.

Further, any of these previously used methods reduce the throughput of water through the membrane and hence their use has to be kept to a minimum, if possible. There are two kinds of particulates that can deposit on the membrane surface: (1) organic, such as sludge, bacterial growth, etc., and (2) inorganic precipitates of insoluble salts of metals such as calcium, magnesium, iron, etc. which form a hard scale that can only be dissolved by strong acids. Biological growth is usually prevented by using biocides such as hypochlorite, ozone dissolved in water, etc.

Thus, another aspect of the present invention is a method to reliably keep ultrafiltration membranes from clogging without significantly reducing the productivity of the membrane and requiring several control valves. This will be described in greater detail below.

Nanofiltration

As described above, nanofiltration may be used to separate salts and/or solvents from water. Alternatively, or additionally, nanofiltration may be used subsequent to an ultrafiltration process as described above. Nanofiltration is a cross-flow filtration technology which ranges somewhere between ultrafiltration and reverse osmosis. As previously mentioned, nanofiltration differs from ultrafiltration at least in the size of the molecules that are allowed to pass through the membrane. The nominal pore size of the membrane is typically about 1 nanometer. However, nanofilter membranes are typically rated by molecular weight cut-off (MWCO) rather than nominal pore size. The MWCO is typically less than 1000 atomic mass units (daltons). The transmembrane pressure (pressure drop across the membrane) required is lower (up to 3 MPa) than the one used for reverse osmosis, reducing the operating cost significantly.

Nanofiltration is a membrane process that may be used by itself, or may be used sequentially after the ultrafiltration process. The objective of nanofiltration in various aspects of the present invention is to reject the majority of the divalent soluble ionic species that have not been previously precipitated or otherwise removed from the water.

As is known by those of ordinary skill in the art, every salt precipitated has a finite aqueous solubility, and these soluble species will not precipitate below their normal solubility. The concentration of salts in liquids such as produced/brackish water may be decreased by using the organic solvent precipitation process, as described above, (and the concentration of all the salts may be decreased to reduce their osmostic pressure). As is known to those of ordinary skill in the art, the osmotic pressure, Pₒₛₘ, of a solution can be determined experimentally by measuring the concentration of dissolved salts in solution via the equation, Posm=1.19 (T+273)*Σ(mi), where Posm is osmotic pressure (in psi), T is the temperature (in ° C.), and Σ(mi) is the sum of molar concentration of all constituents in a solution. An approximation for Pₒₛₘ may be made by assuming that 1000 ppm of Total Dissolved Solids (TDS) equals about 11 psi (0.76 bar) of osmotic pressure. This approximation comes from the Van't Hoff equation, which is well known to those of ordinary skill in the art: P'osm (atm)=iMRT, where P'osm is in atm, M is the concentration of salt in gmoles/L, R=0.08205746 atm·L·K⁻¹·mol⁻¹, T is the temperature in degrees Kelvin, and i is the dimensionless Van't Hoff factor; 1.19 is the product of R and 14.7, which converts atm into psi, and 155 is the approximate average molecular weight of the divalent and monovalent salts; Each mole of salt yields about 2 ions, and hence the sum of molar concentrations is the sum of the concentration of the positive and negative ions from the salt. The Van't Hoff factor for NaCl is 2.

Further, as is known to those of ordinary skill in the art, the flow of water across a membrane (Q_{w}) depends on the difference between the feed pressure and the osmostic pressure, Posm: Q_{w}=(AP−APₒₛₘ)*Kw*S/d, where Q_{w} is the rate of water flow through the membrane, AP is the hydraulic pressure differential across the membrane, APₒₛₘ is the osmotic pressure differential across the membrane, Kw is the membrane permeability coefficient for water, S is the membrane area, and d is the membrane thickness. This equation is often simplified to: Q_{w}=A*(NDP), where A represents a unique constant for each membrane material type and NDP is the net driving pressure or net driving force for the mass transfer of water across the membrane. The constant “A” is derived from experimental data, and manufacturers supply the “A” value for their membranes.

As described above, the nanofiltration process may be used to remove some or all of the divalent soluble salts that have not been previously precipitated and/or otherwise removed. And so, to accomplish this, in nanofiltration, the feed pressure has to exceed the osmostic pressure of all the soluble divalent salts in the feed water.

As with ultrafiltration (or any other membrane process), it is important to keep the membrane surface clean (i.e., prevent membrane fouling) so that efficient separation can be achieved (while minimizing or eliminating downtime of a system due to membrane cleaning or replacement). Methods to combat fouling of nanofiltration membranes are: (1) air bubbles, which disturb the deposition layer of the salts on the membrane surface; (2) use of antifouling chemicals, which keep these salts in a dissolved state, even when they achieve high concentrations at the membrane surface; (3) back flow, by temporarily decreasing the feed pressure, which causes reverse flow through the membranes, and (4) low pH, i.e., acid conditions, since most salts have a high solubility at low pH. For example, in one embodiment of the present invention, both air injection and back flow may be used, by decreasing the feed pressure below the osmostic pressure of the salts, thereby causing reverse flow through the membranes.

For example, in one embodiment of such a process, one may drop the pressure in the system while liquid is still flowing through the membrane. The pressure may then be caused to drop below osmotic pressure. When this occurs, the osmotic pressure forces a backwards flow through the membrane because the higher concentration water is on the feed side of the membrane. The backwards flow caused by the osmotic pressure consists of low TDS water and dissolves any solids that may have started to precipitate in the membrane.

Further, since water is flowing backwards, some solids and high concentration water flow from the membrane into the feed side of the membrane. These are carried away in the reject stream as pumping of liquid through the entire system is ongoing. In other words, pressure is decreased on the feed side of the membrane below the osmostic pressure, so that water flows backwards from the permeate to the feed side of the membrane. In one embodiment, a reject valve may be opened to allow inlet water to flow through the membrane and out into the reject stream. The pressure in the feed side of the membrane decreases to less than that of the osmotic pressure across the membrane. The water all passes along the membrane surface but does not permeate the membrane due to osmotic pressure. Since the pressure on the feed side is less than the osmotic pressure across the membrane, water flows from the permeate side to the feed side where it joins the flow on the feed side and exits through the reject pressure control valve.

Reverse Osmosis

Reverse osmosis is a water purification technology that uses a semipermeable membrane. In reverse osmosis, an applied pressure is used to overcome osmotic pressure, a colligative property, that is driven by chemical potential, a thermodynamic parameter. The result is that the solute is retained on the pressurized side of the membrane and the pure solvent is allowed to pass to the other side. To be “selective,” this membrane should not allow large molecules or ions through the pores (holes), but should allow smaller components of the solution (such as the solvent) to pass freely.

In a normal osmosis process, solvent naturally moves from an area of low solute concentration, through a membrane, to an area of high solute concentration. The movement of a pure solvent is driven to reduce the free energy of the system by equalizing solute concentrations on each side of a membrane, generating osmotic pressure. Reverse osmosis is achieved by applying an external pressure to reverse the natural flow of pure solvent.

In various embodiments of the present invention, reverse osmosis may be used on its own, or may be used sequentially after the nanofiltration process, or may be used in a nanofiltration/reverse osmosis process following ultrafiltration. Once objective of this process is to reject the monovalent ionic species in the water. These ionic species mainly includes salts of sodium, ammonium, and potassium.

Just like in nanofiltration, the osmotic pressure of the monovalent ions has to be overcome to allow water to flow through the membrane. Fouling of the membrane is combated by using all or some of the strategies used for nanofiltration. By reducing the concentration of the monovalent ions, the osmostic pressure that needs to be overcome during reverse osmosis has also been decreased substantially. This reduces power consumption, the fouling tendency of the membrane and the life of the membrane itself.

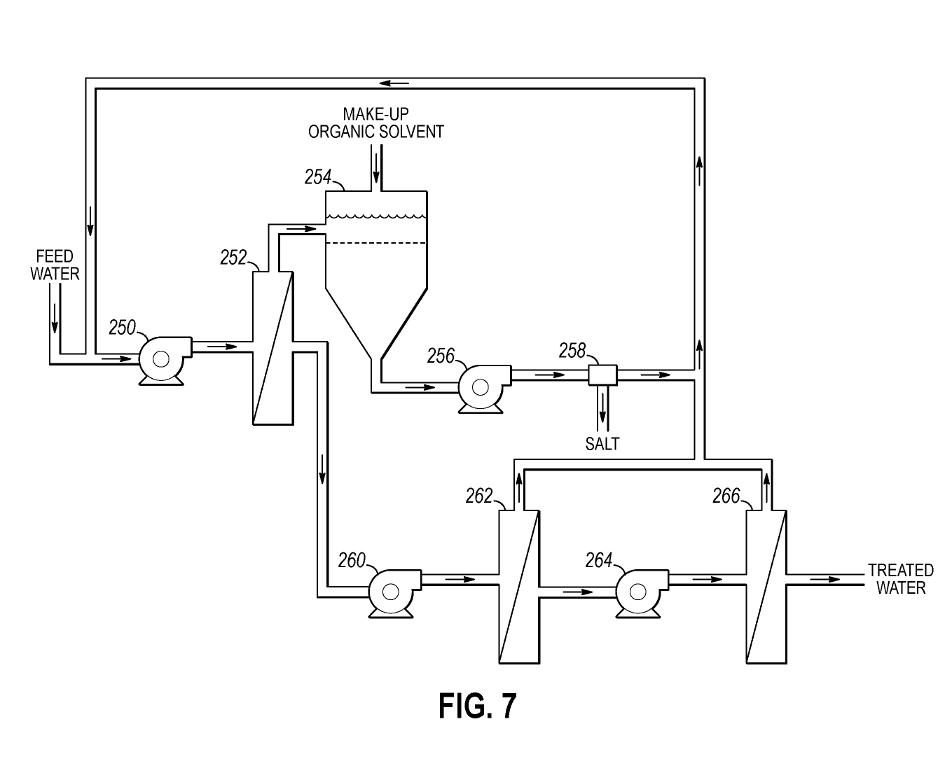

Thus, another possible implementation of the solvent precipitation process is to use an organic solvent that can be recovered using a nanofiltration/reverse osmosis membrane system. As shown in FIG. 7, the solvent can be recycled back, and the reduced concentration of salt in water can be further treated using nanofiltration/reverse osmosis process. In this case, the nanofiltration/reverse osmosis membranes used to reject the solvent mainly have a higher molecular weight cutoff than the membranes that are used subsequently in treating the water. Another possible implementation of the solvent precipitation process, shown in FIG. 7, is using an organic solvent that passes through the nanofiltration membrane, but the nanofiltration membrane is capable of rejecting some salt, and this means that the reject stream from the nanofiltration membrane will have a higher concentration of salt than the feed stream. This reject stream can then be put into the solvent precipitation process, precipitating salt that can be filtered out. The amount of organic solvent needed to achieve a specific lower concentration of salt depends on the inlet salt concentration, as given by equation given earlier in this application, namely, f=αₘᵢₙ+Kα, where α is the mass fraction of solvent needed for precipitation, and f is the fraction of salt that is precipitated. For a salt saturated solution, αₘᵢₙ is =0. However, for an under-saturated salt solution, αₘᵢₙ is finite, and increases as the salt solution gets more and more under-saturated. Hence, if the feed water is under-saturated, then a nanofiltration membrane is used, as shown in FIG. 7, to concentrate the feed to a higher salt concentration, and hence the reject stream entering the settler, has a higher salt concentration, and hence will need lesser solvent to achieve a lower salt concentration. The salt slurry precipitated in the settler is removed from the bottom of the settler and is partly sent to a filter, not shown in FIG. 7, and partly recycled back to the settler feed by pump.

More specifically, and referring to FIG. 7, the feed water enters into feed pump 250 and then flows into a first nanofiltration membrane 252. As described above, the separation performed by the nanofiltration membrane will cause the salt concentration of the reject stream to be increased, and this reject stream is then sent into a settler vessel 254. Additional solvent (make-up solvent) is added to the vessel 254 also, to make up any loss of organic solvent. In the settler vessel 254, salts are precipitated (due to the presence of solvent), and the resulting slurry of water and precipitated salts is removed via pump 256 and sent through filter 258 to remove salt. The liquid (water) that passes through this filter 258 is then recycled back to be combined with additional feed water and be processed through first nanofiltration membrane 252.

The permeate stream that passes through first nanofiltration membrane 252 is then directed via pump 260 to a second nanofiltration membrane 262. The reject stream from this second nanofiltration membrane is recycled back to be combined with feed water and begin the process again by passing through first nanofiltration membrane 252. The permeate stream that passes through second nanofiltration membrane 262 is then directed via pump 264 to a reverse osmosis membrane 266. The reject stream from this reverse osmosis membrane 266 is recycled back to be combined with feed water and begin the process again by passing through first nanofiltration membrane 252. The permeate stream passes through the reverse osmosis membrane as treated water.

The organic/water solution from the settler unit is pumped through a second nanofiltration system that rejects more salt and some organic, and finally the permeate from this nanofiltration membrane is fed into a reverse osmosis membrane that rejects the remaining salt and the remaining solvent. All the reject streams are recycled back, while the permeate stream from the reverse osmosis system is the treated, desalinated water. Since the required pressure difference across the nanofiltration membrane is based on the salt concentration in the feed and in the permeate, by allowing salt water to pass through with some salt rejection in the nanofiltration membranes, the pumps only have to generate the difference between the osmotic pressures of the feed and permeate streams. The following equation gives the net driving pressure across a nanofiltration membrane:

$$NDP = [ ( \frac{{P}_{f} + {P}_{c}}{2} ) - ( {P}_{p} ) ] - [ \{ ( \frac{{TDS}_{f} + {TDS}_{c}}{2} ) - {TDS}_{p} \} \cdot 0.01 \frac{psi}{mg \text{/} L} ]$$

where

NDP=net driving pressure (psi)

P_{f}=feed pressure (psi)

P_{c}=concentrate pressure (psi)

Pₚ=filtrate pressure (i.e., backpressure) (psi)

TDS_{f}=feed TDS concentration (mg/L)

TDS_{c}=concentrate TDS concentration (mg/L)

TDSₚ=filtrate TDS concentration (mg/L)

Membrane systems, such as those described above, may also be used to remove solvent in the presence of salt (without fouling the membranes—or minimizing the fouling of membranes) or may be used to remove both salts and solvent.

As will be described below in Example 2, chemical formulations, such as n-Propyl-amine, can be used to precipitate salts from contaminated water. Subsequently, both the precipitated salts and the organic solvent will need to be removed from the resulting slurry. Membranes may be used for this process. To that end, n-Proply-amine is rejected easier by membranes than multivalent salts are.

Various embodiments of the present invention may include a system that combines a number of the processes described above. For example, in one such embodiment, solvent may be used to precipitate a salt or salts from a liquid (such as water), followed by an ultrafiltration membrane separation process, and subsequently a nanofiltration/reverse osmosis separation process. In such an embodiment, an organic solvent, such as n-Propyl-amine, is to precipitate salts (divalent, monovalent, BOD, COD, etc.) from membrane reject streams, which contain a higher concentration of salts than the feed stream. The reject stream can then be pumped into a settler tank, wherein the organic solvent can be added to precipitate the salts and reduce the contaminants (salts, BOD, COD, etc.) concentration. Dwell time is provided by the settling tank for (1) crystal growth (as crystals grow they gain mass and settle), and (2) settling time (crystals with significant mass need time un-agitated to settle). This is similar to the process described above with respect to FIG. 5. Following this dwell time, the outlet flow from the settling tank will be made up of at least (1) solids that have not reached enough mass to settle in the provided dwell time provided by the settling tank, and (2) water with a high concentration of n-Propyl amine.

Next, this water from the outlet flow of the settling tank may be subjected to ultrafiltration (such as via a ¼″ tube Ultra filter)—similar to the process shown in FIG. 6. More specifically, as water leaves the settling tank, it contains some nucleated low mass solids. These solids are then separated in the ultrafilter system because the nucleated solids are larger than the pores in the ultrafilter. Once they are rejected by the ultrafilter, they are recycled back to the inlet of the settling tank. The low mass solids returned to the inlet of the settling tank provide seeding nucleation sites for further crystal growth. As higher concentrations of solids are achieved in the tank from returning solids from other membrane processes, the crystals grow, thereby gaining mass and settling to the bottom of the tank.

The permeate from the ultrafilter system, however, is clear and passes to a nanofilter system (referred to here as Nanofilter Stage 1).

The purpose of Nanofilter Stage 1 is to reject a percentage of n-Propyl amine and multivalent salts. Nanofilter stage 1 functions as follows: First, water from the dissolved air flotation system is added to the permeate flowing from the Ultrafilter system and enters the Nanofilter Stage 1 nanomembrane filter system. In the particular embodiment of this example, the Nanofilter is a spiral wrapped filter with a membrane spacer of 43 mil thickness. The molecular weight cut off is in a range of 8,000 to 12,000 daltons, and in one embodiment that molecular weight cut off is 10,000 daltons.

During the Nanofilter Stage 1 process, n-Propyl amine, multivalent salts, and water are subjected to the membrane. n-Propyl amine is rejected to a greater extent than that of the water and multivalent salts. This means that the reject stream of the membrane increases in n-Propyl amine concentration. This also means that the n-Propyl amine concentration in the membrane pores decreases in concentration.

No water can enter the membrane pores that is not undersaturated. As an example of this, consider the following: Assume saturation of a multivalent salt is 100,000 mg/L. And assume concentration of n-Propyl amine in solution reduces the concentration of the multivalent salt to 75,000 mg/L. In the pores of the membrane, some of the multivalent salt has been rejected. And a greater percentage of the n-Propyl amine has been rejected. So, what we have is a solution that is unsaturated caused by both: (1) removal of n-Propyl amine, which causes water to have the capacity to hold more salt, and (2) removal of salt, which causes water to have the capacity to hold more salt.

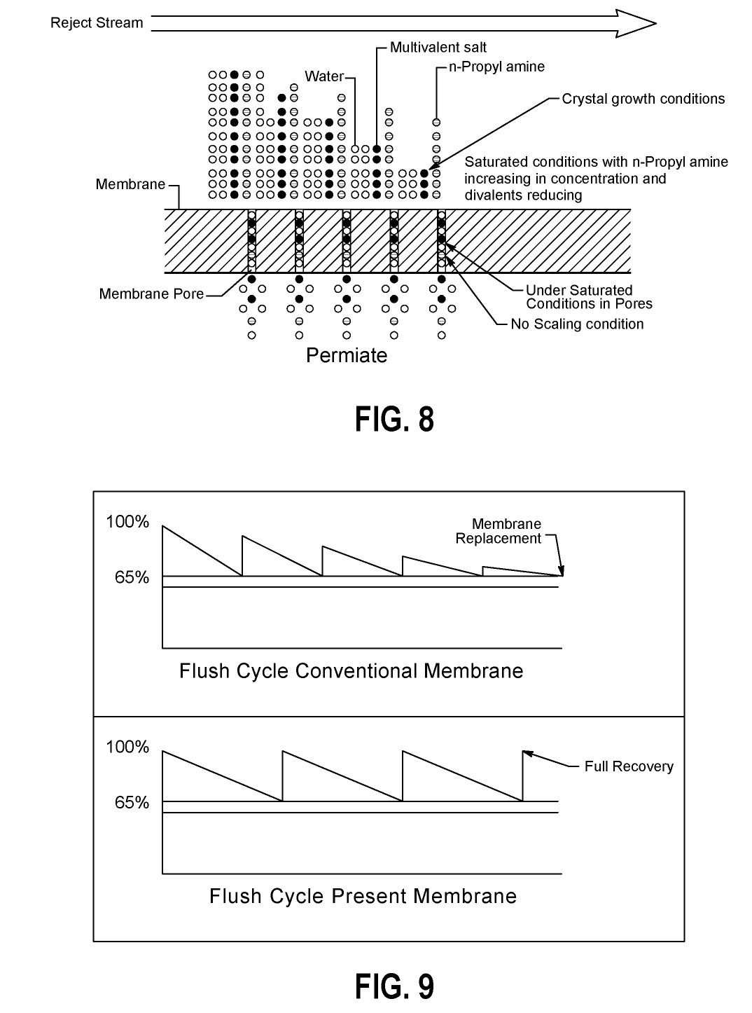

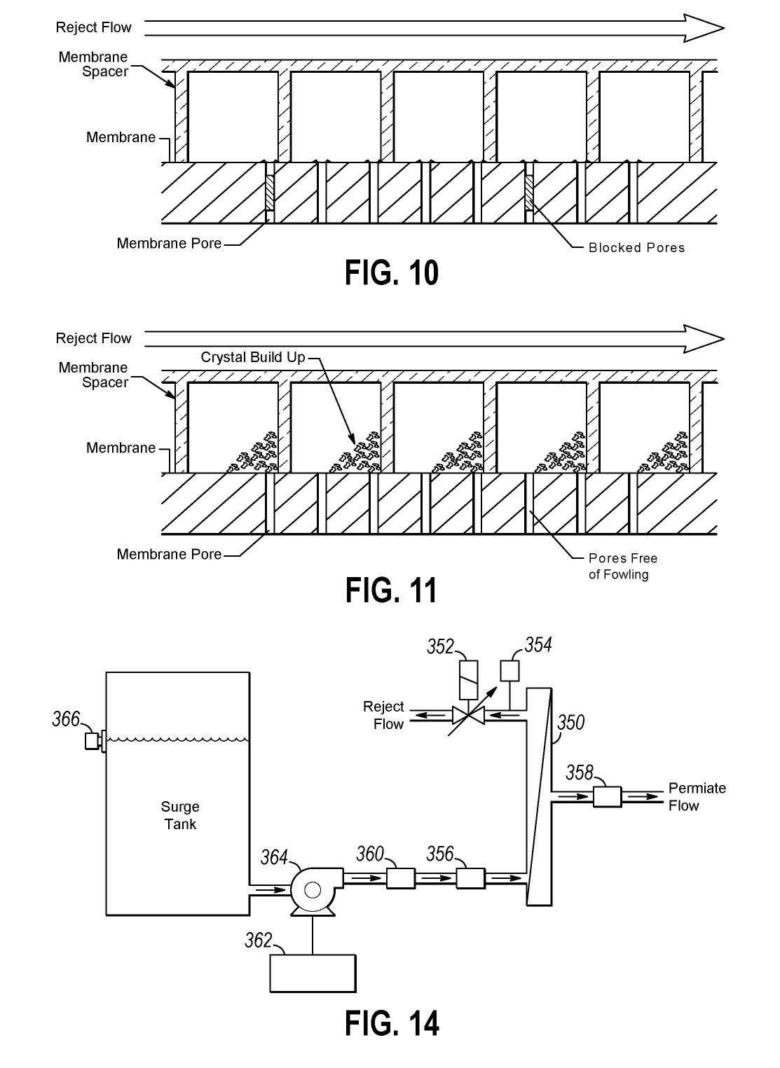

Referring now to FIG. 8, crystals grow in the reject stream and the pores are saved from scaling as the divalent salts and the n-Propyl amine is reduced. When a high TDS (total dissolved solids) solution is pumped through Conventional membranes, fouling occurs within hours. And the system has to be flushed. Each time the system is flushed, recovery is less than 100 percent of previous flow. Pores get blocked and water cannot flow into the pores to unblock the pores. Further, with each passing flush, the membrane becomes more blocked and membrane has to be replaced after a short period of time. This is depicted in FIGS. 9-11. FIG. 8 shows the impact of the organic solvent on the fouling of the membrane due to salt deposition. The presence of the organic solvent on the feed side of the membrane and its presence within the membrane pores actually assists in keeping the salt in solution by forming an under-saturated solution within the membrane. In conventional membranes, the fouling of the membrane due to the deposition of the soluble species on the surface and within the membrane results in a gradual decrease in membrane permeability, as shown in FIG. 9, wherein after each backflush cycle, the membrane water permeability increases but to the same extent as was present before the fouling began, and this gradual decline in permeability limits the number of backflush cycles before the membrane has to be replaced. FIG. 10 shows one of the membrane fouling mechanism, wherein the membrane pores get blocked with precipitated solids, while FIG. 11 sows the mechanism of solids deposition on the membrane surface, which causes decline in membrane permeability. When high TDS solution is pumped through the membranes in the process developed in this Example of the present invention, the reject flow is increased to flush crystals out of the reject stream. Full recovery is experienced with each flush as no pores have been blocked and the crystal build up that created the fouling has been removed. This is also depicted in FIGS. 9-11.

In other words, one major discovery of the solvent precipitation process is that the nanofiltration and even the reverse osmosis membranes will undergo less fouling due to salt deposition when an organic solvent is present in the feed. This is a major finding since fouling of reverse osmosis membranes currently is a major challenge for desalination applications. To fully understand this effect of solvent, we have to look at what causes a membrane that is being used for desalination to foul.

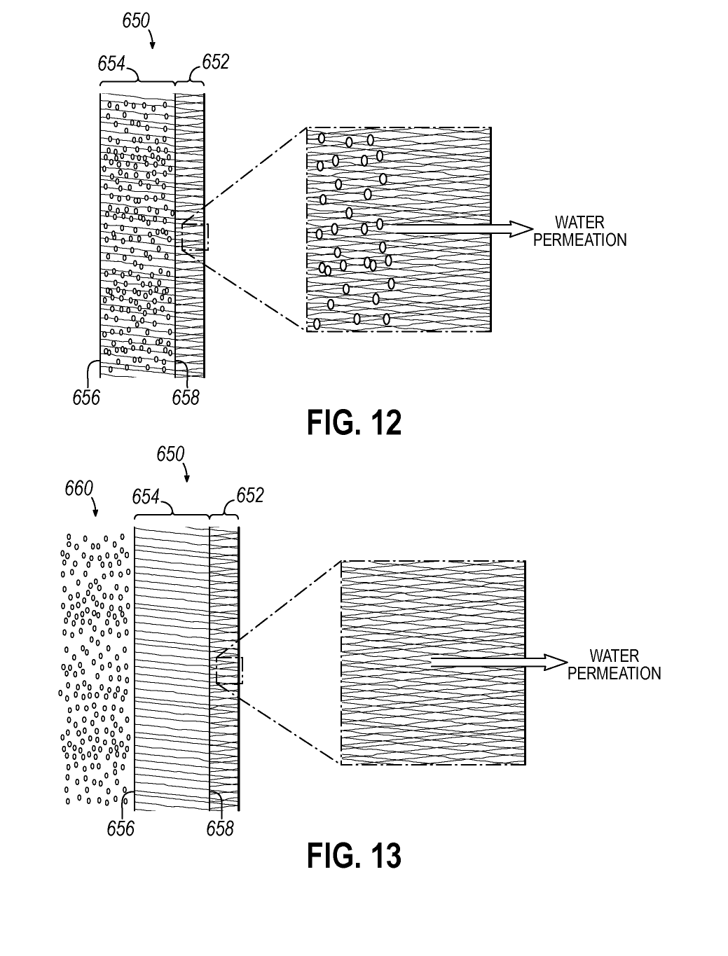

Reverse osmosis membranes have an asymmetrical structure with large pores on one side of the membrane, which decrease in size as you traverse the thickness of the membrane, with a dense layer on the opposite side of the membrane. Membrane fouling occurs due to salt deposition on the membrane surface, which can be periodically cleaned, and also within the membrane structure. This salt deposition occurs due to selective permeation of water through the membrane, and is mainly caused by salt supersaturation, as water moves through the membrane to the permeate side. This is schematically shown in FIG. 12. Salt deposition within the membrane results in irreversible loss of membrane water permeability over time, eventually requiring membrane replacement.

With the presence of the solvent in the feed water, as in the case of the solvent crystallization process, as water selectively permeates through the membrane, the organic solvent concentration increases, and this results in salt crystallization occurring outside the membrane, as shown in FIG. 13. These fine salt crystals continue to flow with the feed water, eventually leaving the membrane module as the reject stream. The main point to emphasize is that the before the salt can deposit inside the membrane, it crystallizes outside the membrane, thereby preventing the occurrence of supersaturation condition within the membrane structure, which results in salt deposition within the membrane, as in the case of normal operation of the membrane without an organic solvent.

The system may include one nanofiltration membrane, or more than one nanofiltration membrane. Each additional Nanofiltration Membrane system functions the same as the Stage 1 filter, removing more n-Propyl amine and divalents. The only difference is control of membrane system to assure saturation of salts is reached in the reject stream. Referring to FIG. 14, controls for the membranes 350 may include: (1) a proportion flow control valve 352, (2) a pressure transducer 354, (3) a first flow meter 356 in the membrane inlet flow, (4) a second flow meter 358 in the membrane permeate flow, (5) a TDS meter or meter to detect n-Propyl amine concentration 360, (6) a variable drive system 362 for a delivery pump 364, and (7) a level sensor 366 for tank control.

Referring to FIG. 14, the proportion flow control valve 352 opens: (1) to reject stream back pressure drops, and (2) to reject stream flow increases. This assures a complete flush of crystal build up in the reject stream of the membrane.

The pressure transducer is on a reject circuit for PLC to control reject back pressure and flush cycles.

Knowing the TDS, the concentration of n-Propyl amine, the flows, and pressure of reject stream, a control system can function the pump to operate and maximum pressure efficiency and use the proportional valve to control pressure required to obtain necessary permeate flow. Also flush cycles can be obtained and performed.

The system and apparatus may also include a reverse osmosis membrane. The reverse osmosis membrane is used to reject the remainder of the n-Propyl amine, to reject traces of divalent salts, and to reject the remainder of the monovalent salts.

Solids removal and flushing of solids to recover n-Propyl amine: Solids from the settling tank are delivered to a filter press with the capability of flushing the solids with a fluid that is to be defined via testing of filter press companies. 150,000 mg/L water is likely the best flushing water for the following reasons: (1) It will not dissolve significant solids in the flushing process; (2) It is readily available from the reverse osmosis reject stream; and (3) It will not deposit significant amount of solids when subjected to n-Propyl amine.

One will also have to allow for handling of contaminants that build up in the plant that do not precipitate. Products that do not precipitate will be of two classes: (1) products such as alkanes (e.g., hexane), and (2) products such as biocides. More specifically, products such as alkanes (hexane) will build up until they float on top of the water in the settling tank and form a layer. A mechanism can be put in place to recognize the presence of the layer and it can be decanted via port on the side of the vessel. And, products such as biocides will build up in concentration and pass through all filter except the reverse osmosis membrane. A maximum concentration will be decided upon and the reverse osmosis reject stream will be “blown down” when concentration reach the targeted maximum. The reverse osmosis reject stream contains the biocides and has the least concentration of n-Propyl amine. This makes it the target for the blow down point. If large amounts of biocides are delivered and blow down requirements grow, it may be necessary to add a small tight membrane to separate the n-Propyl amine from the biocide.

### EXAMPLES

The following Examples further exemplify the principles of the various aspects of the present invention described above.

### Example 1

### Salt Precipitation Via Use of Organic Solvent

This Example demonstrates the precipitation of a salt out of solution via the use of an organic solvent. To that end, water saturated with table salt was prepared by dissolving salt in hot water in a container until un-dissolved salt was observed at the bottom of the container. Then, the salt solution was allowed to cool to room temperature, allowing additional salt to precipitate. The salt-saturated solution was then decanted. The salinity and pH of this salt solution was then measured, and had a salinity of 293,000 ppm and a pH of 6.95.

40 mL of this saturated salt solution was then mixed with differing amounts of isopropyl amine [obtained from, and commercially available from, Sigma-Aldrich company, St. Louis, Mo. (Product No.: 109819)]. After each addition of propylamine, the salt was allowed to precipitate and 40 ml of liquid was decanted off from the top. Table 4 shows the change in the salinity of the decanted salt water, as more and more propylamine was added.

TABLE 4
Change in Salinity of Salt Water after addition of Propylamine.
Specific Gravity of Propylamine 0.69

| | Initial | Propyl- | | Spe- | | |
|---|---|---|---|---|---|---|
| Amt of Salt- | Propyl- | amine | | cific | Vol % | Decant |
| Saturated | amine | added | | Grav- | Propyl- | Salinity |
| Water (mL) | (mL) | (mL) | pH | ity | amine | (ppm) |
| 40 | 0 | 0 | 6.95 | 1.2 | 0.00 | 293,000 |
| 40 | 0 | 4.44 | 9.9 | 1.149 | 9.99 | 253,000 |
| 40 | 0 | 10 | 10.23 | 1.082 | 20.00 | 215,000 |
| 40 | 0 | 17.1 | 10.31 | 1.005 | 29.95 | 168,000 |
| 40 | 0 | 40 | 10.68 | 0.895 | 50.00 | 135,000 |
| 40 | 0 | 120 | 10.84 | 0.782 | 75.00 | 88,000 |

As can be seen from the results in Table 4, as the amount of propylamine was increased in the salt water, more salt precipitated, thereby reducing the salinity in the decanted water. The pH increased since propylamine ionized in water to produce hydroxyl ions in water. By using 75 vol % of propylamine, the salinity in salt water was reduced from the initial value of 293,000 ppm to 88,000 ppm

### Example 2

### Pilot Scale System for Salt Precipitation Via Organic Solvent, with Subsequent Removal of Precipitated Salt and Solvent from Water

As described previously, the methods and apparatus of the present invention may be used in reclamation of water contaminated with various materials (during subsurface geological operations, for example). Thus, ultimately, systems including such methods and apparatus will need to operate at volumes and flow rates dictated by such operations. In order to demonstrate the viability of such methods and apparatus, a pilot-scale system was designed, constructed, and tested.

The system was designed to handle input water (i.e., water entering the system) having saturation levels of (1) naturally occurring radioactive material (e.g., radium, strontium, barium—materials that can become radioactive during processes such as fracking), (2) multivalent salts, (3) monovalent salts, and/or (4) organic materials. The output water (i.e., water exiting the system following treatment) is cleaned to designed specifications, which can be designed to meet potable water requirements.

Although not tested in the pilot system of this Example, the input water may be pretreated prior to introduction into the pilot system, such as with a dissolved air flotation method (e.g., that described in U.S. Application Ser. No. 61/786,942, incorporated by reference herein) to remove materials such as iron and emulsified oils.

The water (whether subjected to pretreatment or not) may be subjected to a precipitation process to remove salts (such as that described in the present application, and for example, as shown in Example 1, above). To accomplish this, chemical formulations having the ability to change the amount of solids that water can dissolve have been developed By “developed” it is meant that mixtures of organic solvents can be developed and used, just like a single organic, such as n-Propyl-amine. In other words, the organic solvent is not limited to being a single chemical only. Further, the use of the organic solvent or these organic solvents does alter the amount of solids (salt, BOD, COD, etc.) that water can dissolve and hence precipitation of solids (salts, BOD, COD, etc.) occurs.

One such chemical formulation is n-Propyl amine. As n-Propyl amine is added to water, an equilibrium between the n-Propyl amine and salt is established in the water. The more n-Propyl amine that is added, the more equilibrium is pushed towards precipitating the salts. Salts will not start to precipitate until the n-Propyl amine has pushed equilibrium to full saturation of the salts in the water.

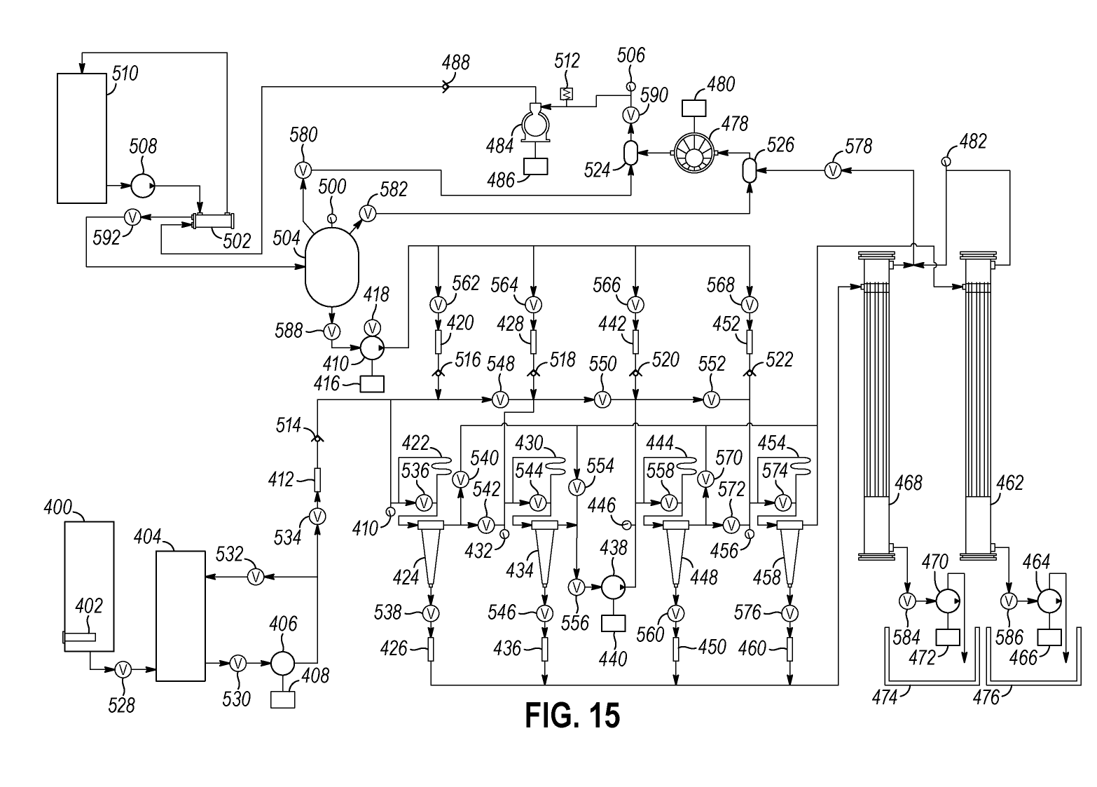

The precipitation of salts and the subsequent reclamation of water by steps including for example, removing salt from the salt slurry that results from salt precipitation, can be accomplished in the pilot scale system of this Example. The pilot scale system is further shown schematically in FIG. 15. The numbered units in the process flow diagram of FIG. 15 are as follows:

| | |
|---|---|
| 400 | Tank for mixing salt into water |
| 402 | Heater to heat water to aid in salt mixing process |
| 404 | Tank for holding salt water |
| 406 | Pump to supply salt water |
| 408 | Variable speed drive salt water supply pump |
| 410 | Gauge pressure 1, (working pressure to supply salt water) |
| 412 | Flow meter, (salt water supply flow) |
| 414 | Pump to supply isopropyl amine |
| 416 | Variable speed drive for isopropyl amine delivery pump |
| 418 | Valve relief to maintain rail pressure for isopropyl amine delivery |
| 420 | Flow meter, (isopropyl amine flow) |
| 422 | Retention coil (a coil of pipe to allow time for crystal growth) |
| 424 | Hydrocyclone |
| 426 | Flow meter, (down flow from hydrocyclone) |
| 428 | Flow meter, (isopropyl amine flow) |
| 430 | Retention coil (a coil of pipe to allow time for crystal growth) |
| 432 | Gauge pressure, (working pressure to hydrocyclone) |
| 434 | Hydrocyclone |
| 436 | Flow meter, (down flow from hydrocyclone) |
| 438 | Pump to boost pressure |
| 440 | Variable speed control for boost pump |
| 442 | Flow meter, (isopropyl amine flow) |
| 444 | Retention coil (a coil of pipe to allow time for crystal growth) |
| 446 | Gauge pressure, (working pressure to hydrocyclone) |
| 448 | Hydrocyclone |
| 450 | Flow meter, (down flow from hydrocyclone) |
| 452 | Flow meter, (isopropyl amine flow) |
| 454 | Retention coil (a coil of pipe to allow time for crystal growth) |
| 456 | Gauge pressure, (working pressure to hydrocyclone) |
| 458 | Hydrocyclone |
| 460 | Flow meter, down flow from Hydrocyclone |
| 462 | Reactor vessel |
| 464 | Pump to control level in reactor |
| 466 | Switch level to control Reactor level |
| 468 | Reactor vessel |
| 470 | Pump to control level in reactor |
| 472 | Switch level to control Reactor level |
| 474 | Tank for precipitate |
| 476 | Tank for salt water with reduced salt concentration |
| 478 | Pump Vacuum to vaporize Isopropyl amine |
| 480 | Variable speed drive for Vacuum pump |
| 482 | Gauge Vacuum, Reactor vessel and pressure |
| 484 | Compressor to compress Isopropyl amine |
| 486 | Drive variable speed for compressor |
| 488 | Valve check, pressure check |
| 500 | Gauge pressure, Compressor working pressure |
| 502 | Shell and Tube heat exchanger to condense Isopropyl amine |
| 504 | Tank for holding liquid isopropyl amine |
| 506 | Gauge pressure vacuum pump outlet |
| 508 | Pump Cooling water |
| 510 | Tank Cold water |
| 512 | Pressure relief for compressor case |
| 514 | Valve check salt water supply |
| 516 | Valve check isopropyl amine supply |
| 518 | Valve check isopropyl amine supply |
| 520 | Valve check isopropyl amine supply |
| 522 | Valve check isopropyl amine supply |
| 524 | Tank compressor intake liquid protection |
| 526 | Tank vacuum pump intake liquid protection |
| 528 | Valve tank shutoff |
| 530 | Valve tank shutoff |
| 532 | Valve bypass |
| 534 | Valve salt water feed shutoff |
| 536 | Valve retention coil bypass |
| 538 | Valve underflow control |
| 540 | Valve flow direction control |
| 542 | Valve flow direction control |
| 544 | Gauge pressure 0-160 psi |
| 546 | Valve underflow control |
| 548 | Valve flow direction control |
| 550 | Valve flow direction control |
| 552 | Valve flow direction control |
| 554 | Valve flow direction control |
| 556 | Valve flow direction control boost pump feed |
| 558 | Valve retention coil bypass |
| 560 | Valve underflow control |
| 562 | Valve Chemical flow control |
| 564 | Valve Chemical flow control |
| 566 | Valve Chemical flow control |
| 568 | Valve Chemical flow control |
| 570 | Valve flow direction control |
| 572 | Valve flow direction control |
| 574 | Valve retention coil bypass |
| 576 | Valve underflow control |
| 578 | Valve vacuum isolation |
| 580 | Valve chemical tank isolation |
| 582 | Valve chemical tank isolation |
| 584 | Valve reactor tank isolation |
| 586 | Valve reactor tank isolation |
| 588 | Valve chemical tank isolation |
| 590 | Valve compressor suction isolation |
| 592 | Valve chemical tank isolation |

Procedures

The operating procedure for the pilot-scale system with reference to FIG. 15 was as follows:

First, an influent (of a saturated salt solution) was prepared in tank 400. To accomplish this, tank 400 was filled with water and heated to 30° C. NaCl was then added to the water in the tank 400, and mixed until no more salt saturated (i.e., similar to the process described above in Example 1). The salinity of the water after salt quit dissolving was measured at 295,000 ppm. In this Example, the salinity was determined by diluting a sample of the salt water 40:1 and testing by conductivity. This process is well known to those of ordinary skill in the art as being useful as a measure of salt concentration when only one salt is being used, as in this Example (NaCl).

Once a saturated solution was achieved, this solution was transferred from tank 400 to tank 404, and four liters of isopropyl amine were added into tank 504 via pump 414. At this point, all valves on the system were closed.

Next, the circulation pump 508 was started and cooling water was circulated from tank 510 through heat exchanger 502. Certain valves were then opened to create a flow path for Step 1 of this Example. More specifically, valve 534 was opened to allow influent (the salt solution) to flow to hydrocyclone 424. Valves 538 and 584 were opened to direct underflow from hydrocyclone 424 to flow through flow meter 426 through reactor 468 to tank 474. Valves 540 and 586 were opened to direct overflow to pass through reactor 462 to holding tank 476. And valves 578, 590, and 592 were opened to create flow path for gases to flow.

Next, a vacuum pump 478 and compressor 484 were prepared for Step 1 of the procedure. A vacuum pressure of 11 inches Hg was drawn on reaction vessels 462 and 468 using vacuum pump 478 (with readout on gauge 482). And, at this point, compressor speed was run to maintain 1 psi pressure between vacuum pump 478 and compressor 484 (with readout on gauge 506). This targets the ideal outlet pressure for the vacuum pump.

Pump 406 (influent pump) was started and a flow rate of 0.85 gpm was established (readout on flow meter 412). Additionally, pump 414 (chemical pump) was started and a flow rate of 0.15 gpm was established (readout on flow meter 420). And the flow rate for underflow hydrocyclone 424 was 0.1 gpm (readout on flow meter 426). In this Example, it was found that a pressure of 92 psi (on pump 406, read on gauge 410) was achieved under these conditions (i.e., to flow 0.85 gpm water and 0.15 gpm isopropyl amine with underflow of hydrocyclone 424 set at 0.1 gpm).

After achieving steady state conditions, it was found that the compressor operated at 53 psi and a flow rate of 2.1 scfm (per compressor rate chart based on rpm and pressure). In the experiment of this Example, rate and pressure were used to estimate the volume of the chemical being recovered, and this was calculated on this first pass to be 35%. [This calculation was made because (1). 15 gpm of isopropyl amine in gaseous state equates to approximately 6 scfm, and thus (2) the volume of isopropyl amine being recovered is 2.1 scfm/6 scfm*100, which equals approximately 35%.]

After this was done, the overflow and underflow from hydrocyclone 424 were checked by taking samples from the liquid entering tanks 474 and 476. The underflow was observed to have a small amount of precipitate. After decanting, the underflow fluid tested to 275,000 ppm NaCl. The overflow was observed to have more precipitated salt than the underflow, since small salt crystals were floating, instead of sinking. This was believed to be due to evaporation of organic solvent into vapor form, which was sticking to the salt crystals, thereby making them lighter. The overflow was decanted and tested to 273,000 ppm NaCl. It is believed that the differences were probably due to fluctuations in the accuracy of testing.

These results of this Step 1 were then compared to previous testing (shown above in Table 4 of Example 1) that indicates that 15 percent isopropyl amine should yield a reduction of salinity to approximately 234,000 ppm. This would equal a reduction of 61000 ppm (295,000 starting point minus 234,000). The underflow yielded a reduction of 20,000 ppm (295,000 minus 275,000) which is approximately 33% of 61,000. The overflow yielded a reduction of 22,000 ppm (295,000 minus 273,000) which is approximately 36% of 61,000. The results from Step 1 thus showed a higher ppm of NaCl than was expected, which showed that not all of the chemical was being removed from the influent.

A second flow was then tested under adjusted conditions. In this step, valve E was opened to add a 24 second retention time to the fluid before it entered the hydrocyclone. Thus, this increased dwell time was used to allow salt crystals additional time to grow and gain mass, to allow the hydrocyclone to separate the salt more efficiently. The second pass was then run under the same remaining conditions as in Step 1, above.

Following this step, it was observed that slightly more precipitate was present in the underflow than on previous step. This indicates that it is possible that crystals were slightly larger than previously (and that more precipitation occurred in the underflow when more time was given for crystal growth). However, the hydrocyclone was unable to separate the precipitate from the fluid. And, recovery of chemical did not change.

The retention coil bypass 422 was then closed by opening valve 536. Flow from pump 406 was decreased to 0.75 gpm using flow meter 412 and variable speed control 408. Flow from pump 414 was increased to 0.25 gpm using flow meter 420 and variable speed control 416. The system was allowed to reach a steady state. Liquid entering into tanks 474 and 476 was observed and recorded, and a sample was taken from liquid entering into tanks 474 and 476. Following these steps, isopropyl amine content was increased from 15% of total volume being passed through the hydrocyclone to 25%. An expected ppm from Table 4 (Example 1) would indicate a target of 192,000 ppm. More salt precipitate was present in the overflow than in the underflow. Same process was used to prepare samples for conductivity testing.

The compressor reached a steady state flow rate of 3.7 scfm. Conductivity measurements were then taken on samples of the under flow and overflow, and the underflow and overflow values were 259,000 ppm and 260,000 ppm respectively.

The flow from hydrocyclone 424 underflow was then increased to 0.2 gpm using flow meter 426 and valve 538. The system was allowed to reach a steady state. Liquid entering into tanks 474 and 476 was observed and recorded, and a sample of liquid entering into tanks 474 and 476 was taken. When measurements were again run on these samples, it was determined that the hydrocyclone performance did not change significantly from the previous passes.

The retention coil bypass 422 was then opened by closing valve 536, and the system was allowed to reach a steady state. Liquid entering into tanks 474 and 476 was observed and recorded, and a sample of liquid entering into tanks 474 and 476 was taken. This time, the retention coil was activated to give 22 extra seconds of retention time for salt crystals to grow. All other settings remained as they were prior to these steps. It was observed that an equal amount of salt was passed from the underflow and the overflow.

Retention coil bypass 422 was then closed by opening valve 536. Flow from pump 406 was set to 0.7 gpm using flow meter 412 and variable speed control 408. Flow through pump 414 was adjusted to 0.15 gpm (flow meter 420). Hydrocyclone 424 underflow was adjusted to 0.1 gpm using flow meter 426 and valve 562. Flow of isopropyl amine was adjusted through flow meter 428 to 0.05 gpm using valve 564. Hydrocyclone 434 underflow was adjusted to 0.05 gpm using valve 546. Valve 556 was opened to direct flow through pump 438. The speed through pump 438 was controlled with variable speed control 440 was used to maintain flow rates through hydrocyclones 448 and 458. Valve 572 was opened to direct flow through hydrocyclone 458. Valve 540 was closed to force flow to go through all hydrocyclones. The underflow for hydrocyclone 448 was set at 0.05 gpm (readout on flow meter 450). The underflow for hydrocyclone 458 was set at 0.05 gpm (readout on flow meter 460). The flow rate through pump 414 was set to 0.05 gpm (readout on flow meter 442). The flow rate through pump 414 was set to 0.05 gpm (readout on flow meter 452). Pump 406 pressure was 110 psi (gauge 410). Pressure into hydrocyclone 434 was 96 psi (gauge 432). Pressure into hydrocyclone 448 was 86 psi (gauge 446). And pressure into hydrocyclone 458 was 70 psi (gauge 446). All hydrocyclones were run in series.

Samples were then taken from the underflow and overflow after running through the hydrocyclones. From Table 4 (Example 1), the final concentration should be 168,000 ppm. a reduction of 56.9% of total salt in solution. Equivalent precipitate was observed in both underflow and overflow. Underflow sample was tested to have 254,000 ppm while the overflow sample was tested to have 256,000 ppm. The compressor ran steady state at 3.6 scfm. It does not appear that incremental usage of hydrocyclones would make much difference. Salt precipitate showed up in both underflow and overflow samples. Each sample was decanted and let sit to evaporate solvent. Vacuum pressure was increased to 18 inches Hg. System was allowed to reach a steady state.

The previous tests were repeated to see if increased recovery of the chemical would be experienced. The results were that the compressor rate increased from 3.6 to 4.7 scfm. There was an increase in vacuum of 7 inches Hg. The increase in flow of chemical was 1.1 scfm.

All of the retention coils were then opened to see if separation of precipitates from fluid would increase significantly. However, no significant change was observed.

Thus, there were two objectives for the pilot scale test of Example 2: (1) to show that the organic solvent, n-Propyl-amine, could be used to reduce the salt concentration in the water due to salt precipitation; and (2) the salt crystals could be separated by hydrocyclones. The experimental test proved the first objective, namely, that the use of organic solvent can reduce the salt concentration. However, it also showed that the hydrocyclones were unable to separate the fine salt crystals, since evaporation of the solvent caused the crystals to float instead of sinking and leaving with the bottoms flow in the hydrocyclone. The fact that n-propyl-amine has a low boiling point and can easily evaporate was the cause of hydrocyclone filure and hence by using a larger molecular weight organic, that has a higher boiling point, this evaporation of the organic can be eliminated and then the hydrocyclones can easily separate the precipitated salt. Further, an adjustment of dwell times has been shown to allow the salt crystals to grow to a size where they settle more rapidly, and so the system may be optimized as needed (which is within the skill of one of ordinary skill in the art).

### Example 3

### Other Methods of Separating Solvent from Water

Another possible implementation of the solvent precipitation process is to use a non-vaporizing separation system, such as a membrane. If the organic molecule has a high molecular weight, such as a sugar, then a simple ultrafiltration membrane can be used to recover the solvent, as shown in FIG. 6. As is described in more detail above, the feed water is pumped by a pump 200 into the settler tank 202, wherein the organic solvent causes precipitation of the soluble species (salts, BOD, COD, etc.), and these precipitates settles down in the settler. Some of the slurry from the bottom of the settler is recycled back by pump 206 to the feed of the settler, to make the salt crystals serve as nuclei for further salt precipitation and allow the salt crystals to grow in size and hence settle faster in the settler. The clear liquid from the settler is pumped by pump 208 into an ultrafiltration membrane, wherein the solvent is separated by the membrane and recycled back, while the salt water permeates through the membrane and is further processed to separate the salt from the water. The solvent precipitation process is able to reduce the salt concentration to manageable levels, and the organic solvent being used is recycled back. The slurry that is taken out of the system by valve 204, which is not recycled back to the settler, is further filtered using a conventional filter, not shown in FIG. 6, wherein the solids are separated from the salt solution and the salt solution is recycled back to the settler. Since there is some loss of solvent with the wet solids that are separated by the filter, not shown in FIG. 6, make-up solvent is added to the settler. The solvent can be recycled back and the salt water that passes through the ultrafiltration membrane can be further treated using a nanofiltration/reverse osmosis process. The main advantage of this solvent precipitation process is to reduce the salt concentration in the feed water, which will further reduce the osmotic pressure needed to use nanofiltration/reverse osmosis membranes to subsequently purify the water. The reject streams from the nanofiltration/reverse osmosis membranes can all be recycled back to the inlet of the solvent precipitation process.

Another possible implementation of the solvent precipitation process is to use an organic solvent that can be recovered using a nanofiltration/reverse osmosis membrane system. As shown in FIG. 7, the solvent can be recycled back, and the reduced concentration of salt in water can be further treated using nanofiltration/reverse osmosis process. In this case, the nanofiltration/reverse osmosis membranes used to reject the solvent mainly have a higher molecular weight cutoff than the membranes that are used subsequently in treating the water.

Another possible implementation of the solvent precipitation process, shown in FIG. 7, is using an organic solvent that passes through the nanofiltration membrane, but the nanofiltration membrane is capable of rejecting some salt, and this means that the reject stream from the nanofiltration membrane will have a higher concentration of salt than the feed stream. The amount of organic solvent needed to achieve a specific lower concentration of salt depends on the inlet salt concentration, as given by equation given earlier in this application, namely, f=αₘᵢₙ+Kα, where α is the mass fraction of solvent needed for precipitation, and f is the fraction of salt that is precipitated. For a salt saturated solution, αₘᵢₙ is =0. However, for an under-saturated salt solution, αₘᵢₙ is finite, and increases as the salt solution gets more and more under-saturated. Hence, if the feed water is under-saturated, then a nanofiltration membrane is used, as shown in FIG. 7, to concentrate the feed to a higher salt concentration, and hence the reject stream entering the settler, has a higher salt concentration, and hence will need lesser solvent to achieve a lower salt concentration. The salt slurry precipitated in the settler is removed from the bottom of the settler and is partly sent to a filter, not shown in FIG. 7, and partly recycled back to the settler feed by pump. This reject stream can then be put into the solvent precipitation process, precipitating salt that can be filtered out.

The organic/water solution from the settler unit is pumped through a second nanofiltration system that rejects more salt and some organic, and finally the permeate from this nanofiltration membrane is fed into a reverse osmosis membrane that rejects the remaining salt and the remaining solvent. All the reject streams are recycled back, while the permeate stream from the reverse osmosis system is the treated, desalinated water. Since the required pressure difference across the nanofiltration membrane is based on the salt concentration in the feed and in the permeate, by allowing salt water to pass through with some salt rejection in the nanofiltration membranes, the pumps only have to generate the difference between the osmotic pressures of the feed and permeate streams. The following equation gives the net driving pressure across a nanofiltration membrane:

$$NDP = [ ( \frac{{P}_{f} + {P}_{c}}{2} ) - ( {P}_{p} ) ] - [ \{ ( \frac{{TDS}_{f} + {TDS}_{c}}{2} ) - {TDS}_{p} \} \cdot 0.01 \frac{psi}{mg \text{/} L} ]$$

where

NDP=net driving pressure (psi)

P_{f}=feed pressure (psi)

P_{c}=concentrate pressure (psi)

Pₚ=filtrate pressure (i.e., backpressure) (psi)

TDS_{f}=feed TDS concentration (mg/L)

TDS_{c}=concentrate TDS concentration (mg/L)

TDSₚ=filtrate TDS concentration (mg/L)

If the total dissolved solids (TDS) in the feed, concentrate (reject) and filtrate is high, the net driving pressure (NDP) which has to be generated by the feed pump can be a reasonable number, which means that the operating electrical cost for the process can be acceptable to give an economical process.

One major discovery of the solvent precipitation process is that the nanofiltration and even the reverse osmosis membranes will undergo less fouling due to salt deposition when an organic solvent is present in the feed. This is a major finding since fouling of reverse osmosis membranes currently is a major challenge for various applications (such as desalination applications). To fully understand this effect of solvent, we have to look at what causes a membrane that is being used for desalination to foul.

Reverse osmosis membranes have an asymmetrical structure with large pores on one side of the membrane, which decrease in size as you traverse the thickness of the membrane, with a dense layer on the opposite side of the membrane. Membrane fouling occurs due to salt deposition on the membrane surface, which can be periodically cleaned, and also within the membrane structure. This salt deposition occurs due to selective permeation of water through the membrane, and is mainly caused by salt supersaturation, as water moves through the membrane to the permeate side. This is schematically shown in FIG. 12. The reverse osmosis membrane 650 includes a dense membrane 652, and a portion 654 of lesser density. Portion 654 includes a first surface 656, which is a porous surface having relatively large pores, and a second surface 658 at an interface with the dense membrane. The second surface 658 has smaller pores than the first surface. As water moves through the membrane (as seen in FIG. 12) salt gets deposited within the membrane, resulting in eventual fouling of the membrane. This salt deposition within the membrane results in irreversible loss of membrane water permeability over time, eventually requiring membrane replacement.

However, one aspect of the present invention is the prevention of this membrane fouling. With the presence of the solvent in the feed water, due to the solvent precipitation process of the present invention, as water selectively permeates through the membrane, the organic solvent concentration increases (because the solvent cannot pass through the membrane—thus, the solvent builds up, and there is an increased concentration of solvent on the reject side of the membrane). This increased solvent concentration results in salt crystallization occurring outside the membrane 660 (i.e., on the reject side of the membrane, as shown in FIG. 13. These fine salt crystals continue to flow with the feed water, eventually leaving the membrane module in the reject stream. The main point here is that the before the salt can deposit inside the membrane, it crystallizes outside the membrane and is disposed of in the reject stream, thereby preventing the occurrence of supersaturation condition within the membrane structure, which results in salt deposition within the membrane, as in the case of normal operation of the membrane without an organic solvent. Thus, the membrane does not foul.

Preliminary testing of a membranes with ethylamine as the organic solvent has shown that the rate of water permeation through the membrane gradually declined when there was no solvent present, while with 15 vol % ethylamine in the feed, there was no decrease in the permeate flux with time.

Bench-scale experiments were also conducted to determine the separation of ethylamine from water using a membrane system. Studies on ultrafiltration (UF), nanofiltration (NF) and reverse osmosis (RO) were conducted. The membranes used in this study are given in Table 5.

TABLE 5
Membrane Characteristics - Separation
of Monoethanolamine from Water.

| | Ultra- | Nano- | Reverse |
|---|---|---|---|
| | filtration | filtration | Osmosis |
| Membrane | (UF) | (NF) | (RO) |
| Material | Cellulose | Polyamine | Polyamide |
| | Acetate | | |
| Configuration | Tubular | Tubular | Tubular |
| pH max | 2.0-7.25 | 1.2-11 | 1.1-14 |
| Max. Temperature | 80 | 80 | 80 |
| (deg C.) | | | |
| Maximum Pressure | 30 | 45 | 64 |
| (bar) | | | |
| Apparent Retention | 2000 MW | 60% CaCl₂ | 99% NaCl |
| Hydrophilicity | 5 | 4 | 3 |
| Solvent Resistance | + | ++ | +++ |

Note:
Solvent Resistance: + low, +++ high

Experimental work was conducted using monoethanolamine (MEA) using the membranes listed in the table. Various concentrations of salt water containing 15%, 30%, 50% by volume of monoethanolamine were used in the testing. The concentrations of monoethanolamine in the feed, permeate and reject were determined using a UC-Spectrophotometer. The Rejection Coefficient of the membrane was calculated as follows:

$$R = \frac{( {C}_{p} - {C}_{b} )}{{C}_{b}}$$

where Cₚ=permeate concentration and C_{b} is the bulk concentration.

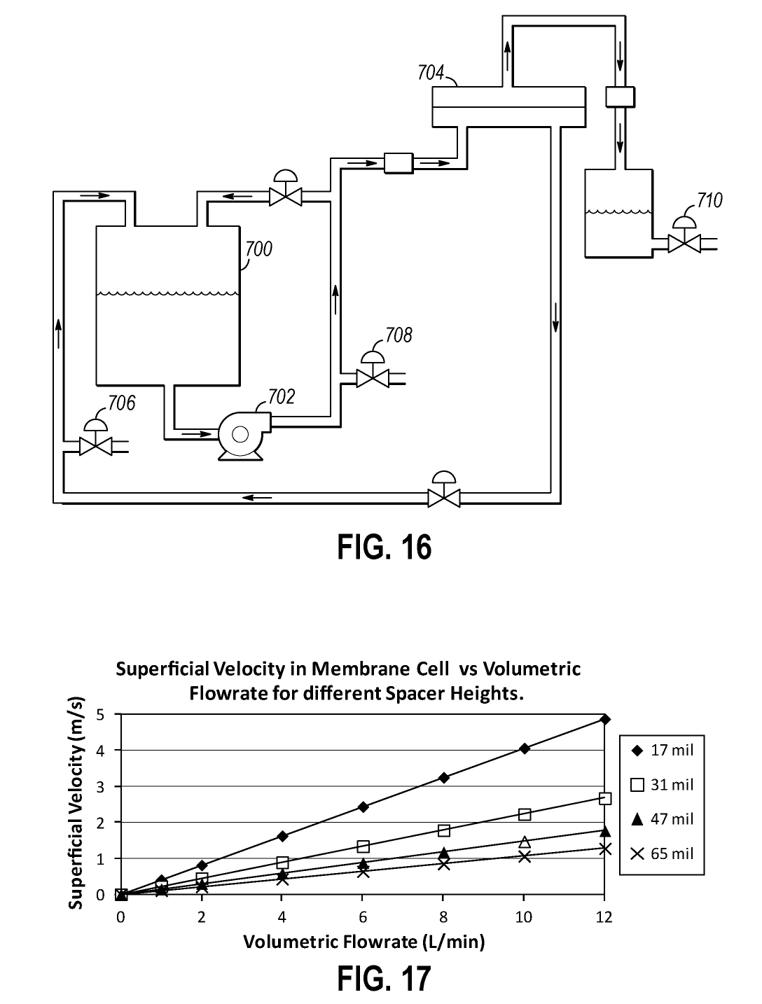

The experimental apparatus for this study is shown in FIG. 16. It consists of a feed tank 700, in which the mixture of organic and salt water are added, a high pressure recycle pump 702, a flat membrane cell 704, in which the UF, NF or RO membrane can be used, and the sampling ports 706, 708, 710 to determine the feed, reject and permeate concentrations of organic in the liquid.

The membrane cell is a cross-flow system in which the permeate flows perpendicular to the feed flow direction. A single piece of rectangular membrane is installed in the base of the cell. A stainless steel support membrane is used as a permeate carrier. The two cell components are assembled using the stainless steel studs as guides. Hand nuts are used to assemble the membrane cell and tighten the rectangular O-ring on the edges of the flat sheet membrane.

The feed is pumped to the feed inlet of the membrane cell, which is located at the bottom of the cell. The feed flows tangentially across the membrane surface, and the fluid velocity can be controlled by the user. The permeate is collected from the center of the cell at the top and is collected in a separate vessel. The reject flow from the membrane is recycled back to the feed tank.

The test system parameters are as follows:

Effective membrane area: 140 cm² (22 inch²)
Maximum Pressure: 69 bars (1,000 psig)
Maximum operating temperature: 177 deg C. (360 deg F.)
Holdup volume: 70 mL

### O-rings: Viton

pH range: Membrane dependent

### Materials of Construction:

Membrane cell body: 316L stainless steel
Top and Bottom plates: 316L stainless steel
Membrane Support: 20 micron sintered 316L stainless steel

### Connections:

Feed: ¼ inch FNPT
Reject: ¼ inch FNPT
Permeate: ⅛ inch FNPT

The flow superficial velocity in the membrane cell versus volumetric flow rates is shown in FIG. 17. As the spacer height is increased the superficial velocity for the flow decreases.

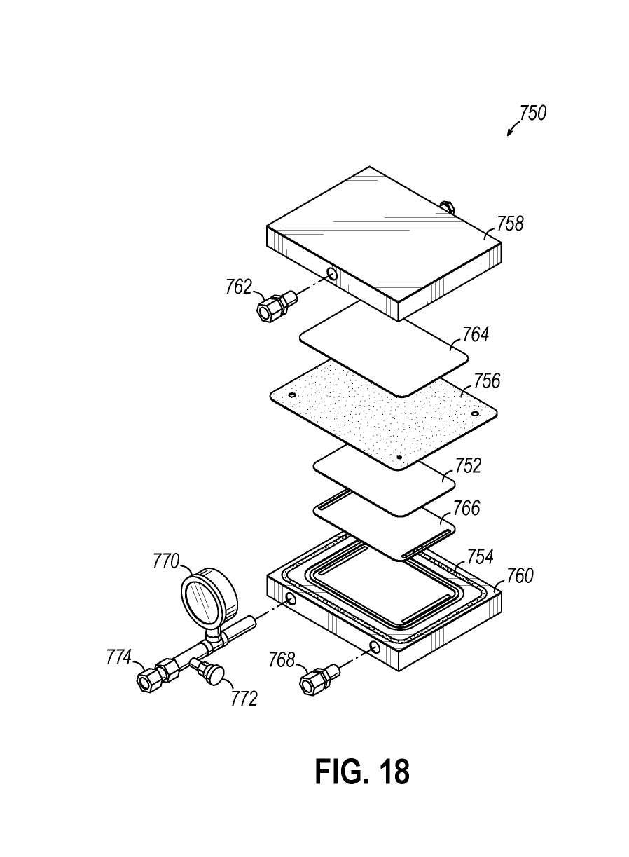

A detailed view of the membrane cell 750, showing the spacer 752, O-ring 754, membrane 756 and flow chambers 758, 760 is shown in FIG. 18. The diagram shows the two chambers for the feed/reject 760 and permeate 758 flows. The feed spacer 752 thickness or height can be varied to obtain different feed flow velocity on the surface of the membrane. The spacer height selected for all the experimental data was 47 mils and the volumetric flowrate was 6 L/min.

The configuration shown in FIG. 18 also includes a permeate outlet 762, permeate carrier 764, shim 766, feed inlet 768, pressure gauge 770, reject flow control valve 772, and reject outlet 774.

Ethanolamine was bought from Sigma-Aldrich company, St Louis, Mo. (Product Number E9508), Formula C₂H₇NO, CAS-No.: 141-43-5. Salt water used in the experiments had the following composition analysis:

| | Analysis Method | | | | | Analyzed | | |
|---|---|---|---|---|---|---|---|---|
| Analyte Name | Reference | Result | MDL | Units | Analyst | Date | Time Started | |
| pH | 4500 H + B | 5.53 | N/A | s.u. | DER | Jun. 7, 2013 | 5:00:00 | PM |
| Calcium, Total (N) | EPA 200.7 | 17100 | 0.149 | mg/L | CDG | Jun. 13, 2013 | 9:50:00 | AM |
| Iron, Total | EPA 200.7 | 94.0 | 0.016 | mg/L | CDG | Jun. 21, 2013 | 10:16:00 | AM |
| Sodium, Total (N) | EPA 200.7 | 64700 | 0.602 | mg/L | CDG | Jun. 13, 2013 | 9:50:00 | AM |
| Strontium, Total | EPA 200.7 | 1380 | 0.002 | mg/L | CDG | Jun. 19, 2013 | 3:17:00 | PM |
| Sulfate | HACH 8051 | 266 | 0.897 | mg/L | DER | Jun. 8, 2013 | 10:32:00 | AM |
| Alkalinity, Bicarbonate (HCO3) N | SM 2320 B | 52.5 | 2.0 | mg/L | DER | Jun. 9, 2013 | 10:31:00 | AM |
| Alkalinity, Carbonate (CO3) N | SM 2320 B | <2.0 | 2.0 | mg/L | DER | Jun. 9, 2013 | 10:31:00 | AM |
| Alkalinity, Tot(CaCO3) - Screen | SM 2320 B | 52.5 | 2.0 | mg/L | DER | Jun. 9, 2013 | 10:31:00 | AM |
| Chloride | SM 4500 Cl C | 200000 | 1.7 | mg/L | VNR | Jun. 14, 2013 | 3:04:00 | PM |

* All analytes R - samples should be stored and transported on ice or with ice packs.
* pH Q - measured upon receipt to the laboratory.
* Aliquot for Metals (Ca, Fe, Sr, Na) split and preserved with HNO3 upon receipt to the laboratory to pH <2.
* Sulfate and Chloride F
* Calcium, Sodium and Strontium F
* Alkalinity N
* Calcium B
* Iron F

Table 6 gives the effect of operating pressure and feed concentration on permeate flux using RO membrane (cross-flow velocity=6 L/min and pH=3)

TABLE 6
Effect of operating pressure and feed
concentration on RO membrane flux.

Monoethanolamine concentration (v/v)

| | | | |
|---|---|---|---|
| Operating Pressure | 15% | 30% | 50% |

| | |
|---|---|
| (bar) | Membrane Flux (L/h · m²) |

| | | | |
|---|---|---|---|
| 7.5 | 12 | 10 | 8 |
| 13 | 25 | 20 | 18 |
| 20 | 40 | 36 | 30 |
| 25 | 45 | 40 | 35 |

As can be seen, the permeate flux increases with operating pressure, and as the Monoethanolamine concentration is increased from 15 vol % to 50 vol %, there is a decrease in membrane flux. The corresponding fluxes for the NF and UF membranes are given in Tables 7 and 8, respectively.

TABLE 7
Effect of operating pressure and feed
concentration on NF membrane flux.

Monoethanolamine concentration (v/v)

| | | | |
|---|---|---|---|
| Operating Pressure | 15% | 30% | 50% |

| | |
|---|---|
| (bar) | Membrane Flux (L/h · m²) |

| | | | |
|---|---|---|---|
| 7.5 | 42 | 39 | 36 |
| 13 | 61 | 57 | 54 |
| 20 | 106 | 96 | 90 |
| 25 | 120 | 110 | 100 |

TABLE 8
Effect of operating pressure and feed
concentration on UF membrane flux.

Monoethanolamine concentration (v/v)

| | | | |
|---|---|---|---|
| Operating Pressure | 15% | 30% | 50% |

| | |
|---|---|
| (bar) | Membrane Flux (L/h · m²) |

| | | | |
|---|---|---|---|
| 7.5 | 62 | 59 | 54 |
| 13 | 82 | 76 | 72 |
| 20 | 147 | 140 | 137 |
| 25 | 167 | 160 | 154 |

The membrane rejections for the RO, NF and UF membranes are given in Tables 9, 10, and 11, respectively.

TABLE 9
Effect of operating pressure and feed concentration
on RO membrane rejection coefficient. (Cross-flow
velocity = 6 L/min; pH = 3)

Monoethanolamine concentration (v/v)

| | | | |
|---|---|---|---|
| Operating Pressure | 15% | 30% | 50% |

| | |
|---|---|
| (bar) | Rejection Coefficient |

| | | | |
|---|---|---|---|
| 7.5 | 0.995 | 0.992 | 0.990 |
| 13 | 0.998 | 0.996 | 0.995 |
| 20 | 1.0 | 0.997 | 0.995 |
| 25 | 1.0 | 0.997 | 0.995 |

TABLE 10
Effect of operating pressure and feed concentration
on NF membrane rejection coefficient. (Cross-flow
velocity = 6 L/min; pH = 3)

Monoethanolamine concentration (v/v)

| | | | |
|---|---|---|---|
| Operating Pressure | 15% | 30% | 50% |

| | |
|---|---|
| (bar) | Rejection Coefficient |

| | | | |
|---|---|---|---|
| 7.5 | 0.65 | 0.62 | 0.60 |
| 13 | 0.72 | 0.70 | 0.68 |
| 20 | 0.78 | 0.74 | 0.72 |
| 25 | 0.82 | 0.80 | 0.78 |

TABLE 11
Effect of operating pressure and feed concentration
on UF membrane rejection coefficient. (Cross-flow
velocity = 6 L/min; pH = 3)

Monoethanolamine concentration (v/v)

| | | | |
|---|---|---|---|
| Operating Pressure | 15% | 30% | 50% |

| | |
|---|---|
| (bar) | Rejection Coefficient |

| | | | |
|---|---|---|---|
| 7.5 | 0.35 | 0.33 | 0.30 |
| 13 | 0.44 | 0.40 | 0.37 |
| 20 | 0.49 | 0.45 | 0.42 |
| 25 | 0.54 | 0.50 | 0.48 |

Clearly, from the data shown in the Examples above, ethanolamine can be separated from salt water using UF, NF and RO. The separation efficiency decreases as we go from a porous membrane, i.e., UF and NF to a dense film, such as in RO. The highest separation efficiency would be attained by RO. By staging in sequence the UF, NF and RO membranes, it is possible to achieve a very high removal efficiency for the solvent, in this case, ethanolamine.

While the present invention has been disclosed by reference to the details of preferred embodiments of the invention, it is to be understood that the disclosure is intended as an illustrative rather than in a limiting sense, as it is contemplated that modifications will readily occur to those skilled in the art, within the spirit of the invention and the scope of the amended claims.

1. A method of precipitating a water soluble salt or water soluble salts from water, the method comprising:
adding a water-miscible solvent to a water solution including an inorganic salt, wherein the water-miscible solvent is characterized by:
a. infinite solubility in water at 25° C.;
b. a boiling point of greater than 25° C. at 0.101 MPa;
c. a heat of vaporization of about 0.5 cal/g or less; and
d. no tendency to azeotrope with water;
wherein the mass ratio of the water-miscible solvent to the total volume of aqueous mixture is about 0.05 to 0.3.

2. The method of claim 1, wherein the inorganic salt is sodium chloride.

3. The method of claim 1, wherein the water solution is brine.

4. The method of claim 3, wherein the brine is water produced by a mining operation.

5. The method of claim 4, wherein the brine has been pretreated to remove one or more materials comprising oily residues, gel particles, suspended solids, strontium, calcium, or a mixture of two or more thereof.

6. The method of claim 1, wherein the water-miscible solvent is an organic solvent or inorganic solvent.

7. The method of claim 1, wherein the water-miscible solvent is a mixture of two or more solvents.

8. The method of claim 1, wherein the water-miscible solvent is chosen from methylamine, dimethylamine, trimethylamine, ethylamine, acetaldehyde, methylformate, isopropylamine, propylene oxide, dimethoxymethane, t-butylamine, propionaldehyde, N-propylamine, allylamine, diethylamine, acetone, s-butylamine, or a mixture of two or more thereof.

9. The method of claim 8, wherein the water-miscible solvent is ethylamine.

10. A method of precipitating and concentrating water soluble salts from water, the method comprising
a. forming an aqueous mixture by adding a water-miscible solvent to a water solution of an inorganic salt, the water-miscible solvent characterized by infinite solubility in water at 25° C., a boiling point of greater than 25° C. at 0.101 MPa, a heat of vaporization of about 0.5 cal/g or less, and no tendency to azeotrope with water, wherein the mass ratio of the water-miscible solvent to the total volume of aqueous mixture is about 0.05 to 0.3;
b. separating precipitated salt from the aqueous mixture; and
c. evaporating the water-miscible solvent from the water.

11. The method of claim 10, wherein the inorganic salt is sodium chloride.

12. The method of claim 10, wherein the water solution is brine.

13. The method of claim 12, wherein the brine is water produced by a mining operation.

14. The method of claim 13, wherein the brine has been pretreated to remove one or more materials comprising oily residues, gel particles, suspended solids, strontium, calcium, or a mixture of two or more thereof.

15. The method of claim 10, wherein the mass ratio of the water-miscible solvent to the total volume of aqueous mixture is achieved over two to twenty individual repetitions of steps a. and b. such that the final mass ratio after the two to twenty repetitions is about 0.05 to 0.3.

16. The method of claim 10, wherein the separating is accomplished by using a hydrocyclone apparatus.

17. The method of claim 10, wherein the evaporation is carried out in high surface area tubes, the evaporation further comprising a source of air flow through the tubes, a source of vacuum attached to the tubes, or both.

18. The method of claim 10, wherein between about 70% and 95% by weight of the salt present in the water solution is separated.

19. The method of claim 10, wherein about 90% to 99.9% of the water miscible solvent is evaporated.

20. The method of claim 10, wherein the water-miscible solvent is an organic solvent or inorganic solvent.

21. The method of claim 10, wherein the water-miscible solvent is a mixture of two or more solvents.

22. The method of claim 10, wherein the water-miscible solvent is chosen from methylamine, dimethylamine, trimethylamine, ethylamine, acetaldehyde, methylformate, isopropylamine, propylene oxide, dimethoxymethane, t-butylamine, propionaldehyde, N-propylamine, allylamine, diethylamine, acetone, s-butylamine, or a mixture of two or more thereof.

23. The method of claim 22, wherein the water-miscible solvent is ethylamine.

24. A method of separating a salt or salts from a solution containing dissolved salts and a solvent, comprising:
passing a solution including a liquid, dissolved salts, and a solvent through a membrane having a first side and a second side and is adapted to have a structure or configuration that does not allow the solvent to pass through the first side of the membrane;
wherein solvent concentration increases on the first side of the membrane, and such increased solvent concentration precipitates the salt out of the solution.

25. The method of claim 24, further comprising recapturing the rejected solvent for reuse in precipitating a salt.

26. The method of claim 24, wherein the membrane is chosen from an ultrafiltration membrane, a nanofiltration membrane, and a reverse osmosis membrane.

27. A method of preventing the fouling of a membrane, comprising:
providing a solvent on a first side of a membrane, wherein the solvent is provided at a concentration capable of precipitating a salt out of solution; and
passing a solution having a soluble salt therein through said first side of said membrane;
wherein said solution first contacts said solvent, and said salt precipitates out of solution prior to passing through said first surface of said membrane and into said membrane.

28. The method of claim 27, further comprising, removing said salt from said solvent.
